(19) United States
(12) Patent Application Publication
(10) Pub. No.: US 2024/0103331 A1
(43) Pub. Date: Mar. 28, 2024

(54) FLEXIBLE CONTROLS FOR SMART GLASS

(71) Applicant: SAGE Electrochromics, Inc., Faribault, MN (US)

(72) Inventor: Bryan D. Greer, Northfield, MN (US)

(73) Assignee: SAGE Electrochromics, Inc., Faribault, MN (US)

(21) Appl. No.: 18/470,345

(22) Filed: Sep. 19, 2023

Related U.S. Application Data
(60) Provisional application No. 63/376,939, filed on Sep. 23, 2022.

(51) Int. Cl. G02F 1/163; H02J 7/00

(52) U.S. Cl. CPC G02F 1/163; H02J 7/0063

(57) ABSTRACT

An electrochromic (EC) device is provided. The EC includes an electrical channel for providing electrical communication with at least one other EC device. The EC device also includes a battery configured to supply electrical power to the EC device and the at least one other EC device via the electrical channel. The EC device further includes a controller configured to control the battery to supply electrical power to at least one of the EC device or the other EC device.

### PRIORITY CLAIM

This application claims benefit of priority to U.S. Provisional Application Ser. No. 63/376,939, entitled “FLEXIBLE CONTROLS FOR SMART GLASS,” filed Sep. 23, 2022, and which is hereby incorporated herein by reference in its entirety.

### BACKGROUND

Electrically switchable glass may include a type of glass or glazing for which light transmission properties of the glass or glazing are altered when electrical power (e.g., voltage/current) is applied to the electrically switchable glass. For example, electrically-switchable glass may include suspended particles that are organized or that revert to a disorganized state based on the application of electrical power. Also, electrically-switchable glass may include electrochromic materials that change in opacity when electrical power is applied. Some electrochromic materials may maintain a level of opacity resulting from the application of an electrical voltage, even after the electrical voltage is no longer applied. Also, electrically-switchable glass may include polymer dispersed liquid crystals that may be ordered in an aligned configuration or a non-aligned configuration which causes light to be allowed or impeded from passing through the electrically switchable glass, wherein the alignment of the liquid crystals is controlled by applying electrical power to the material.

Controllers may control electrically switchable glass by controlling a voltage or current applied to the electrically switchable glass. Systems with a plurality of electrically switchable glass panes may use a large number of wires each routed to a specific location(s) so that the controller can control each of the panes. However, it may be a challenge to get a large number of wires labelled and routed to a specification location so that the controller (or control system) knows which pane is which.

### BRIEF DESCRIPTION OF THE DRAWINGS

FIG. 1 illustrates an example of a wired system for controlling one or more panes according to some aspects.

FIG. 2 illustrates an example of a wired system for controlling one or more panes according to some aspects.

FIG. 3 illustrates an example of a wireless system for controlling one or more panes according to some aspects.

FIG. 4 illustrates an example of a system for controlling one or more panes according to some aspects.

FIG. 5 illustrates an example pane system according to some aspects.

FIGS. 6A and 6B illustrate an example pane system having a compartment according to some aspects. FIG. 6A illustrates a front view of the example pane system having the compartment. FIG. 6B illustrates a side view of the example pane system having the compartment.

FIGS. 7A and 7B illustrate an example pane system having a compartment according to some aspects. FIG. 7A illustrates a front view of the example pane system having the compartment. FIG. 7B illustrates a side view of the example pane system having the compartment.

FIG. 8 illustrates an example method of manufacturing a pane system including a compartment according to some aspects.

FIGS. 9A, 9B, and 9C illustrate example pane systems including a power receiving device according to some aspects.

FIGS. 10A and 10B illustrate an example pane system according to some aspects. FIG. 10A illustrates a front view of the example pane system having the compartment. FIG. 10B illustrates a side view of the example pane system having the compartment.

FIG. 11 illustrates an example pane system utilizing solar power according to some aspects.

FIG. 12 illustrates an example pane system utilizing a paired solar power configuration according to some aspects.

FIG. 13 illustrates an example pane system utilizing a shared power source according to some aspects.

FIG. 14 illustrates an example pane system utilizing solar power and selectively utilizing an additional power source according to some aspects.

FIG. 15 illustrates an example pane system utilizing a shared power source for both power usage and power storage according to some aspects.

FIG. 16 illustrates an example of a computing system according to some aspects.

While embodiments are described herein by way of example for several embodiments and illustrative drawings, those skilled in the art will recognize that the embodiments are not limited to the embodiments or drawings described. It should be understood that the drawings and detailed description thereto are not intended to limit embodiments to the particular form disclosed, but on the contrary, the intention is to cover all modifications, equivalents and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). The words “include,” “including,” and “includes” indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for nouns that they precede, and do not imply any type of ordering (e.g., spatial, temporal, logical, etc.) unless such an ordering is otherwise explicitly indicated.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

Electrically switchable glass (e.g., an electrochromic device, an IGU) may include a type of glass or glazing for which light transmission properties of the glass or glazing are altered when electrical power (e.g., voltage/current) is applied to the electrically switchable glass. For example, electrically-switchable glass may include suspended particles that are organized or that revert to a disorganized state based on the application of electrical power. Also, electrically-switchable glass may include electrochromic materials that change in opacity when electrical power is applied. Some electrochromic materials may maintain a level of opacity resulting from the application of an electrical voltage, even after the electrical voltage is no longer applied. Also, electrically-switchable glass may include polymer dispersed liquid crystals that may be ordered in an aligned configuration or a non-aligned configuration which causes light to be allowed or impeded from passing through the electrically switchable glass, wherein the alignment of the liquid crystals is controlled by applying electrical power to the material.

Controllers may control electrically switchable glass by controlling a voltage or current applied to the electrically switchable glass. Systems with a plurality of electrically switchable glass panes may use a large number of wires each routed to a specific location(s) so that the controller can control each of the panes. However, it may be a challenge to get a large number of wires labelled and routed to a specification location so that the controller (or control system) knows which pane is which. Also, it is often difficult for installers to manage the large mass of wires and, in some cases, retrofit the large mass of wires into an existing structure or building. Further, if there is no predefined wiring, then control output lines from a controller may need to be manually associated with respective panes and/or manually associated with respective pane locations in order to control respective panes. This may be particularly challenging and time consuming because electrically switchable glass (e.g., electrochromic glass) switches (e.g., changes opacity) very slowly increasing the time to confirm that a pane and/or a pane location is properly associated with an proper outline attached to a controller. In addition, if there are wiring faults in a wired system, locating those faults and fixing them may be time consuming and difficult.

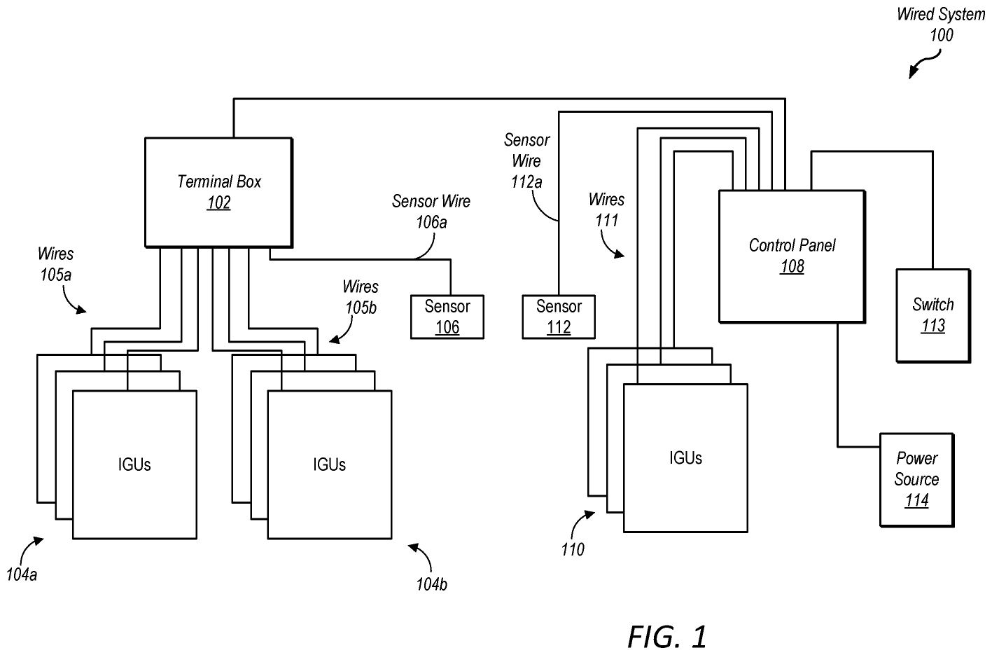

FIG. 1 illustrates an example of a wired system 100 for controlling one or more panes according to some aspects. As shown in FIG. 1, the wired system 100 may include a terminal box 102, a first set of one or more insulated glass units (IGUs) 104a in wired communication with the terminal box 102 via respective wires 105a, a second set of one or more insulated glass units (IGUs) 104b in wired communication with the terminal box 102 via respective wires 105b, a first sensor 106 in wired communication with the terminal box 102 via the sensor wire 106a. The wired system 100 may also include control panel 108 in wired communication with the terminal box 102, a third set of one or more IGUs 110 in wired communication with the control panel 108 via respective wires 111, a second sensor 112 in wired communication with the control panel 108 via the sensor wire 112a, a switch 113 in wired communication with the control panel 108, and a power source 114 (e.g., an alternating power source) in wired communication with the control panel 108.

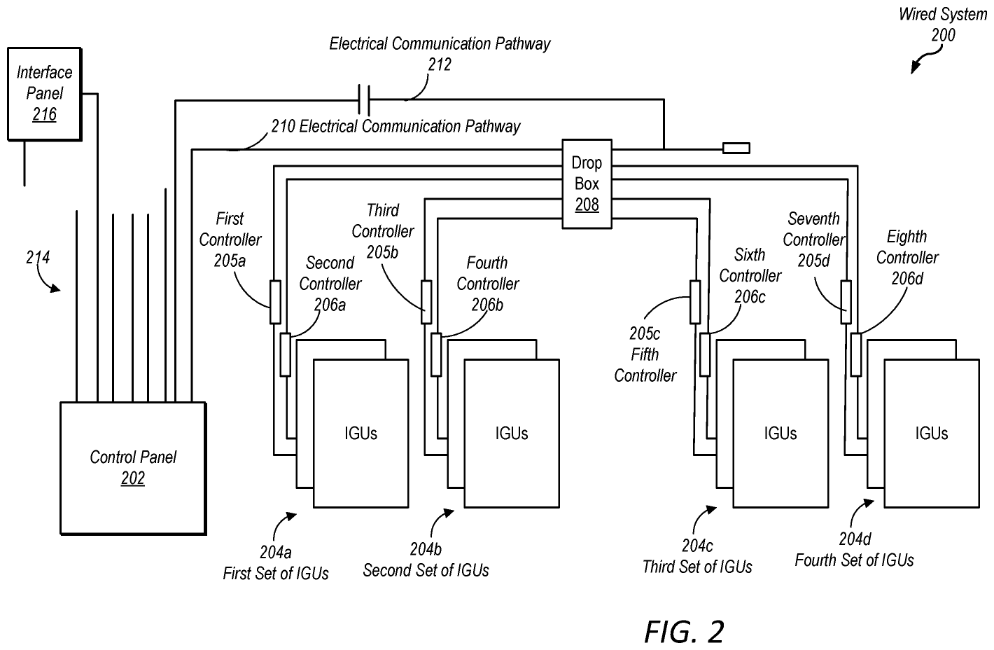

FIG. 2 illustrates an example of a wired system 200 for controlling one or more panes according to some aspects. As shown in FIG. 2, the wired system 200 may include a control panel 202, a first set of one or more IGUs 204a in wired communication with the control panel 202, a second set of one or more IGUs 204b in wired communication with the control panel 202, a third set of one or more IGUs 204c in wired communication with the control panel 202, and a fourth set of one or more IGUs 204d in wired communication with the control panel 202. Each of the individual IGUs from each set of one or more IGUs 204a, 204b, 204c, and 204d may have a controller. For example, a first IGU from the first set of one or more IGUs 204a in wired communication with the control panel 202 may be controlled by a first controller 205a, a second IGU from the first set of one or more IGUs 204a in wired communication with the control panel 202 may be controlled by a second controller 206a, a first IGU from the second set of one or more IGUs 204b in wired communication with the control panel 202 may be controlled by a third controller 205b, a second IGU from the second set of one or more IGUs 204b in wired communication with the control panel 202 may be controlled by a fourth controller 206b, a first IGU from the third set of one or more IGUs 204c in wired communication with the control panel 202 may be controlled by a fifth controller 205c, a second IGU from the third set of one or more IGUs 204c in wired communication with the control panel 202 may be controlled by a sixth controller 206c, a first IGU from the fourth set of one or more IGUs 204d in wired communication with the control panel 202 may be controlled by a seventh controller 205d, and a second IGU from the fourth set of one or more IGUs 204d in wired communication with the control panel 202 may be controlled by an eighth controller 206d.

The wired system 200 may also include a drop box 208 providing wired electrical communication, via the electrical communication pathways 210 and 210, between each of the IGUs (and their respective controllers) and the control panel 202 for both power and electrical communication. The control panel 202 may be in wired communication with an interface panel 216. Using, for example, the control panel 202 via the interface pane 216, the controllers 205a, 206a, 205b, 206b, 205c, 206c, 205d, and 206d may be programmed to control and modulate the opacity of the set of one or more IGUs 204a, 204b, 204c, and 204d, respectively.

As previously described herein, controllers may control electrically switchable glass by controlling a voltage or current applied to the electrically switchable glass. As shown in FIGS. 1 and 2, systems with a plurality of electrically switchable glass panes may use a large number of wires each routed to a specific location so that the controller(s) can control each of the panes. However, labelling and routing the large number of wires to a specific location so that controller(s) (or control system) know(s) which pane is which may be a challenge. Also, installers may incur additional time and costs managing and installing a large mass of wires and, in some cases, retrofitting a large mass of wires into an existing structure or building. Further, if there is no predefined wiring, then control output lines from a controller or controllers may need to be manually associated with respective panes and/or manually associated with respective pane location(s) in order to control respective panes. Manually associating panes and controllers may be particularly challenging and time consuming because electrically switchable glass (e.g., electrochromic glass) switches (e.g., changes opacity) very slowly increasing the time to confirm that a pane and/or a pane location is properly associated with an proper outline attached to a controller. In addition, if there are wiring faults in a wired system, locating those faults and fixing them may be time consuming and difficult.

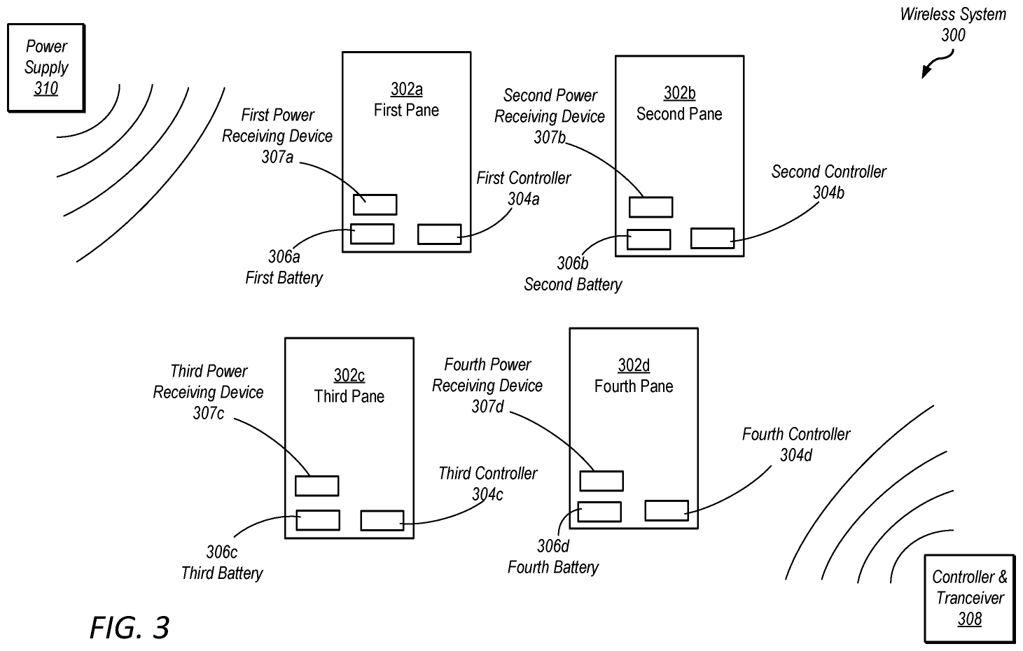

FIG. 3 illustrates an example of a wireless system 300 for controlling one or more panes according to some aspects. In some aspects, the wireless system 300 may include one or more same or similar features as the wired system 100 illustrated in FIG. 1 and/or the wired system 200 illustrated in FIG. 2. As shown in FIG. 3, the wireless system 300 may include one or more panes including a first pane (e.g., IGU) 302a, a second pane 302b, a third pane 302c, and a fourth pane 302d. Each of the panes may include a controller and/or a battery. For example, the first pane 302a may include a first controller 304a and a first battery 306a, the second pane 302b may include a second controller 304b and a second battery 306c, the third pane 302c may include a third controller 304c and a third battery 306c, and the fourth pane 302d may include a fourth controller 304d and a fourth battery 306d. Each of the controllers may be coupled the respective panes and configured to receive one or more wireless control signals (e.g., via an antenna) from the controller and transceiver device 308 for controlling an opacity of the respective pane. For example, each of the controllers may be embedded within a sealed cavity within the pane, coupled to a surface of the pane, or stored within an accessible recess or pocket of the pane. In some aspects, the panes may include power receiving devices. For example, the first pane 302a may include a first power receiving device 307a, the second pane 302b may be include a second power receiving device 307b, the third pane 302c may include a third power receiving device 307c, and the fourth pane 302d may include a fourth power receiving device 307d. Each of the power receiving devices may be coupled the respective panes and configured to receive wireless power from the power supply 310. For example, each of the batteries may be embedded within a sealed cavity within the pane, coupled to a surface of the pane, or a stored within an accessible recess or pocket of the pane. In some aspects, the power supply 310 may include a wireless power transmitter and the power receiving devices may include an antenna for receiving wireless power from the wireless power transmitter. Additionally, or alternatively, the power supply 310 may include a solar power source (e.g., the sun) and the power receiving devices may include a solar panel for receiving solar power from the solar power source. Each of the batteries may be coupled with the respective panes and configured to supply a voltage to change an opacity of the respective panes. For example, each of the batteries may be embedded within a sealed cavity within the pane, coupled to a surface of the pane, or a stored within an accessible recess or pocket of the pane.

As described herein, the wireless system 300 may include a power supply 310 configured to wirelessly transmit power to each of the respective panes for changing an opacity of the respective panes. In this case, the batteries may be used as an additionally power supply along with the power supply 310 to provide power to the panes for supplying a voltage to change an opacity of the panes. Additionally, or an alternatively, the batteries may act as a backup power supply (a back-up to the power supply 310) to provide power to the panes for supplying a voltage to change an opacity of the panes, when, for example, the power supply 310 is unable to supply power or when the power supply 310 is unable to supply enough power to the panes. In some aspects, the power supply 310 may transmit power to the batteries for power storage. Subsequently, the batteries may supply a voltage to change an opacity of the respective panes using the power received from the power supply 310. In some aspects, each of the panes may include a solar panel so that when the power supply 310 includes a solar power supple (e.g., the sun), electrical power converted from solar power via the solar panel may be used for changing an opacity of a pane. In some aspects, solar panels, other power receiving device, batteries, power sources, and the like, as described herein, may be integrated into an EC device or may be external to the EC device and may be in electrical communication with a controller and/or the EC device via an external electrical channel.

As described herein, the wireless system 300 may have panes that may be fully controlled wirelessly. Further, the wireless system 300 may have panes that are independently powered (e.g., self-powered) through battery storage and wireless power transmissions including solar power and wireless power transfer system. However, with solar power, obstructions may impede the transmission of power to at least some panes so that some panes have less power for changing opacity than others. Also, with wireless power transfer systems (e.g., radio, IR) some panes may have difficulty receiving adequate power due, for example, to obstructions and/or distances between the panes and the wireless power transfer source.

In some cases, the controllers may control whether power is sent from the respective solar panels directly to the respective panes, whether power is sent from the respective power receiving devices to the respective batteries for subsequent transmission to the respective panes, and/or whether power is sent from the batteries to the respective panes. For example, the first controller 304a may determine that the first battery 306a is fully charged and that the power received by the first power receiving device 307a is sufficient to change and/or maintain a tint of the first pane 302a at a specified rate and/or a specified level of tinting (e.g., an amount of tinting). As such, the first controller 306a may direct power from the first power receiving device 307a to the first pane 302a to change and/or maintain a tint of the first pane 302a while preventing power from communicating from the first power receiving device 307a to the first battery 306a. As another example, the second controller 304b may determine that a second battery 306b is only partially charged and that tinting is not currently needed for the second pane 302b. As such, the second controller 306b may direct power from the second power receiving device 307b to the second battery 306b for power storage and/or may prevent power from being supplied directly from the second power receiving device 307b to the second pane 302b. As yet another example, the third controller 304c may determine that the third battery 306c is at least partially charged, that the third power receiving device 307c is not able to provide power or a sufficient amount of power (e.g., independently), and that power is needed to maintain and/or change a tinting of the third pane 302c. As such, the third controller 304c may direct power from the third battery 306c to the third pane 302c. In some aspects, the third controller 304c may also direct power from the third power receiving device 307c to the third pane 302c and/or to the third battery 306c to use and/or store at least some electrical power from the third power receiving device 307c. As yet another example, the fourth controller 304d may determine that the fourth pane requires an amount of power to achieve a specified rate of tint change and/or maintain a specified amount of tinting for the fourth pane 302d that may require both power stored in the fourth battery 306d and power provided by the fourth power receiving device 307d. As such, the fourth controller 304d may controller the fourth power receiving device 307d to provide power directly to the fourth pane 302d and may controller the fourth battery 306d to provide power directly to the further pane 302d.

In some cases, the controllers may control an amount of power sent from the power receiving devices to at least one of the respective panes or the respective batteries. For example, the first controller 304a may direct a transmission of a first amount of power from the first power receiving device 307a to the first pane 302a and a second amount of power (e.g., a remaining amount of power) from the first power receiving device 307a to the first battery 306a for subsequent use by the first pane 302a. Additionally, or alternatively, the first controller 304a may direct a transmission of a first amount of power from the power receiving device 307a to the first pane 302a and a second amount of power (e.g., a supplemental amount of power) from the first battery 306a to the first pane 302a.

In some aspects, a controller of a respective pane may control the amount of electrical power supplied from the power receiving device to the pane based on at least one of an amount of light received by the power receiving device or an amount of electrical power stored in the battery. For example, the first controller 304a may determine that the first battery 306a is at least partially charged and that the first power receiving device 307a is receiving an amount of power below a threshold for enabling the first power receiving device 307a to independently supply enough electrical power to the first pane 302a. As such, the first controller 304a may control the first power receiving device 307a to supply as much electrical energy as possible to the first pane 302a and control the first battery 306a to supply a remainder amount of electrical power to meet the demands of the first pane 302a.

In some aspects, a controller of a respective pane may control an amount of electrical power supplied from a respective power receiving device to a respective battery based on at least one of an amount of light received by the power receiving device and an amount of electrical power stored in the battery. For example, the first controller 304a may determine that the first battery 306a is not fully charged and that the first power receiving device 307a is receiving more than sufficient amount of power for enabling the first power receiving device 307a to independently supply enough electrical power to the first pane 302a. As such, the first controller 304a may control the first power receiving device 307a to supply a sufficient amount of electrical power to maintain and/or change an opacity of the first pane 302a and supply a remainder amount of electrical power to charge the first battery 306a.

In some aspects, a controller of a respective pane may control an amount of electrical power supplied from the battery to the pane. For example, the first controller 304a may determine that the first battery 306a is not fully charged and that the first pane 302a does not require tinting and thus does not require electrical power to maintain or change a tint of the first pane 302a. Further, the first controller 304a may determine that the first power receiving device 307a is receiving at least some electrical power. As such, the first controller 304a may control the first power receiving device 307a to supply electrical power from the first power receiving device 307a to the first battery 306a to charge the first battery 306a.

In some aspects, a controller of a respective pane may control the amount of electrical power supplied from the battery to the pane based on at least one of an amount of power received by the power receiving device and an amount of electrical power stored in the battery. For example, the first controller 304a may determine that the first battery 306a is at least partially charged and that the first power receiving device 307a is not able to receive electrical power for the first pane 302a. As such, the first controller 304a may control the first battery 306a to supply electrical power to meet the demands (or at least attempt to meet the demands) of the first pane 302a.

In some cases, a controller of a respective pane may control the amount of electrical power sourced from at least one of the power receiving device or the battery based on at least one of an amount of light received by the pane, an amount of opacity specified for the pane, a rate of change of an amount of opacity specified for the pane. For example, the first controller 304a may determine current power sourcing capabilities of the first battery 306a and/or the first power receiving device 307a and control the amount of power sourced to the first pane 302a based on the current power sourcing capabilities of the first battery 306, the current power sourcing capabilities of the first power receiving device 307a, an amount of opacity specified for the first pane 302a at a particular time (or duration of time), and/or a rate of change of an amount of opacity specified for the first pane 302a at a particular time (or a duration of time). In some cases, a controller of a respective pane may control at least one of power receiving device or the battery to source electrical power to the pane based on at least one of a power demand of the pane, an available amount of power to be sourced from the battery, or an available amount of power to be sourced from the power receiving device.

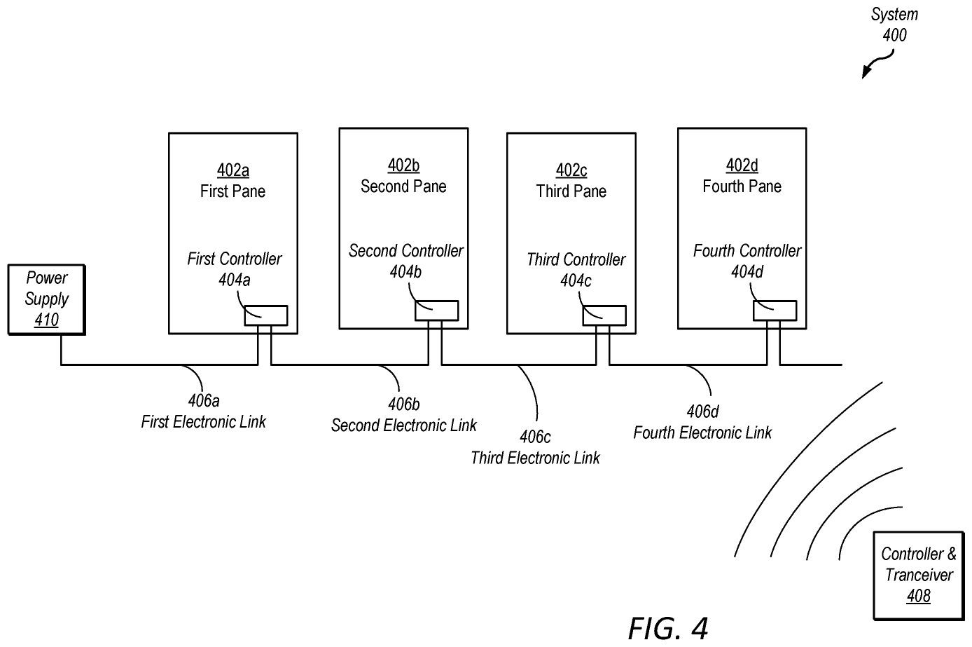

FIG. 4 illustrates an example of a system 400 for controlling one or more panes according to some aspects. In some aspects, the system 400 may include one or more same or similar features as the wired system 100 illustrated in FIG. 1, the wired system 200 illustrated in FIG. 2, and/or the wireless system 300 illustrated in FIG. 3. As shown in FIG. 4, the system 400 may include a plurality of panes including a first pane (e.g., IGU) 402a, a second pane 402b, a third pane 402c, and a fourth pane 402d. Each of the panes may include a controller. For example, the first pane 402a may include a first controller 404a, the second pane 402b may include a second controller 404b, the third pane 402c may include a third controller 404c, and the fourth pane 402d may include a fourth controller 404d. Each of the controllers may be coupled with the respective panes and configured to control an opacity of the respective pane. Each of the controllers may be embedded within a sealed cavity within the pane, coupled to a surface of the pane, a stored within an accessible recess or pocket of the pane. Each of the controllers may include one or more electronic links (e.g., a wired connections) that connect controllers to at least one other controller and/or a power supply. In some aspects, each of the controllers are electrically linked to each other via the electronic links arranged in a daisy-chain configuration. For example, the first controller 404a may include a first electronic link 406a for electrically connecting the first controller 404a to the power supply 410. The first controller 404a may also include a second electronic link 406b for electrically connecting the first controller 404a to the second controller 404b. The first controller 404a may be configured to control power received from the power supply 410 and for controlling an opacity of the first pane 402a using a voltage from the power supply 410 via the first electronic link 406a. For example, upon receiving a signal (e.g., a wireless signal) from the controller and transceiver 408, the first controller 404a may control an amount of power received from the power supply 410 and modulate a voltage through the first pane 402a to change an opacity of the first pane 402a in accordance with the signal.

The second controller 404b may be configured to control power received from the power supply 410 and for controlling an opacity of the second pane 402b using a voltage from the power supply 410 via the first electronic link 406a and a second electronic link 406b. For example, upon receiving a signal (e.g., a wireless signal) from the controller and transceiver 408, the second controller 404b may control an amount of power received from the power supply 410 and modulate a voltage through the second pane 402b to change an opacity of the second pane 402b in accordance with the signal.

The first controller 404a may also include the second electronic link 406b for electrically connecting the first controller 404a to the second controller 404b. The second electronic link 406b may also be for electrically connecting the second controller 404b to the power supply 410 via the first electronic link 406a and the first controller 404a. In some aspects, the first controller 404a may be configured to control a distribution of power from the power supply 410 via the first electronic link 406a and to the second electronic link 406b for supplying power to one or more other controllers associated with the remaining panes. For example, upon receiving a signal (e.g., a wireless signal) from the controller and transceiver 408, the second controller 404b may transmit a signal to the first controller 404a, via the second electronic link 406b, directing the first controller 404a to provide an amount of power to the second controller 404b from the power supply 410 and via the first electronic link 406a and the second electronic link 406b so that the second controller 404b may modulate a voltage through the second pane 402b to change an opacity of the second pane 402a in accordance with the signal. As another example, upon receiving a signal (e.g., a wireless signal) from the controller and transceiver 408, the first controller 404a may provide an amount of power to the second controller 404b from the power supply 410 and via the first electronic link 406a and the second electronic link 406b so that, upon receiving another signal (or the same signal) from the controller and transceiver 408, the second controller 404b may modulate a voltage through the second pane 402b to change an opacity of the second pane 402b in accordance with the other signal.

The third controller 404c may be configured to control power received from the power supply 410 and for controlling an opacity of the third pane 402c using a voltage from the power supply 410 via the first electronic link 406a, the second electronic link 406b, and a third electronic link 406c. For example, upon receiving a signal (e.g., a wireless signal) from the controller and transceiver 408, the third controller 404c may control an amount of power received from the power supply 410 and modulate a voltage through the third pane 402c to change an opacity of the third pane 402c in accordance with the signal.

The second controller 404b may be electrically connected to the third electronic link 406c for electrically connecting the first controller 404a and second controller 404b to the third controller 404c. The third electronic link 406c may also be for electrically connecting the third controller 404c to the power supply 410 via the first electronic link 406a, the first controller 404a, the second electronic link 406b and the second controller 404b. In some aspects, the first controller 404a and/or the second controller 404b may be configured to control a distribution of power from the power supply 410 via the first electronic link 406a and the second electronic link 406b and to the third electronic link 404c for supplying power to one or more other controllers associated with the remaining panes. For example, upon receiving a signal (e.g., a wireless signal) from the controller and transceiver 408, the third controller 404c may transmit a signal to the first controller 404a and the second controller 404b, via the second electronic link 406b and the third electronic link 406c, directing the first controller 404a and/or the second controller 404b to provide an amount of power to the third controller 404c from the power supply 410 and via the first electronic link 406a, the second electronic link 406b, and the third electronic link 406c so that the third controller 404c may modulate a voltage through the third pane 402c to change an opacity of the third pane 402c in accordance with the signal. As another example, upon receiving a signal (e.g., a wireless signal) from the controller and transceiver 408, the first controller 404a and the second controller 404b may provide an amount of power to be communicated to the third controller 404c from the power supply 410 and via the first electronic link 406a, the second electronic link 406b, and the third electronic link 406c so that, upon receiving another signal (or the same signal) from the controller and transceiver 408, the third controller 404c may modulate a voltage through the third pane 402c to change an opacity of the third pane 402c in accordance with the other signal.

The fourth controller 404d may be configured to control power received from the power supply 410 and for controlling an opacity of the fourth pane 402d using a voltage from the power supply 410 via the first electronic link 406a, the second electronic link 406b, the third electronic link 406c, and a fourth electronic link 406d. For example, upon receiving a signal (e.g., a wireless signal) from the controller and transceiver 408, the fourth controller 404d may control an amount of power received from the power supply 410 and modulate a voltage through the fourth pane 402d to change an opacity of the fourth pane 402d in accordance with the signal.

The third controller 404c may be electrically connected to the fourth electronic link 406d for electrically connecting the first controller 404a, the second controller 404b, and the third controller 404c to the fourth controller 404c. The fourth electronic link 406d may also be for electrically connecting the fourth controller 404d to the power supply 410 via the first electronic link 406a, the first controller 404a, the second electronic link 406b, the second controller 404b, the third electronic link 406c, and the third controller 404c. In some aspects, the first controller 404a, the second controller 404b, and/or the third controller 404c may be configured to control a distribution of power from the power supply 410 via the first electronic link 406a and the second electronic link 406b, and the third electronic link 404c to the fourth electronic link 404d for supplying power to one or more other controllers associated with the remaining panes. For example, upon receiving a signal (e.g., a wireless signal) from the controller and transceiver 408, the fourth controller 404d may transmit a signal to the first controller 404a, the second controller 404b, and/or the third controller 404c, via the second electronic link 406b, the third electronic link 406c, and/or the fourth electronic link 406d, directing the first controller 404a, the second controller 404b, and/or the third controller 404c to provide an amount of power to the fourth controller 404d from the power supply 410 and via the first electronic link 406a, the second electronic link 406b, the third electronic link 406c, and the fourth electronic link 406d so that the fourth controller 404d may modulate a voltage through the fourth pane 402d to change an opacity of the fourth pane 402d in accordance with the signal. As another example, upon receiving a signal (e.g., a wireless signal) from the controller and transceiver 408, the first controller 404a, the second controller 404b, and/or the third controller 404c may provide an amount of power to be communicated to the fourth controller 404d from the power supply 410 and via the first electronic link 406a, the second electronic link 406b, the third electronic link 406c, and the fourth electronic link 404d so that, upon receiving another signal (or the same signal) from the controller and transceiver 408, the fourth controller 404d may modulate a voltage through the fourth pane 402d to change an opacity of the fourth pane 402d in accordance with the other signal.

It should be understood that the power supply 410 may have enough power to support peak transition of all the panes on the electronic links. In some aspects, sensors and/or LEDs may also be integrated into the panes for configuring the panes during installation. For example, a light sensor of a pane may be used to change a tint of the pane for pane identification and configuration during installation. As another example, an LED may blink instantly to identify a particular pane rather than allowing time to see or receive an indication, via a sensor, of a change in opacity of the pane. As another example, a light sensor of a pane may be used during operation to detect a change in amount of light receive by the pane in order to change a tint of the pane. As yet another example, an LED may blink to identify that a pane may require maintenance during operation of the pane. It should be also understood that multiple electronic links (e.g., with flexible polarity) may share a same electrical connection point at the respective controllers or may have separate or individualized electrical connection points at respective controllers.

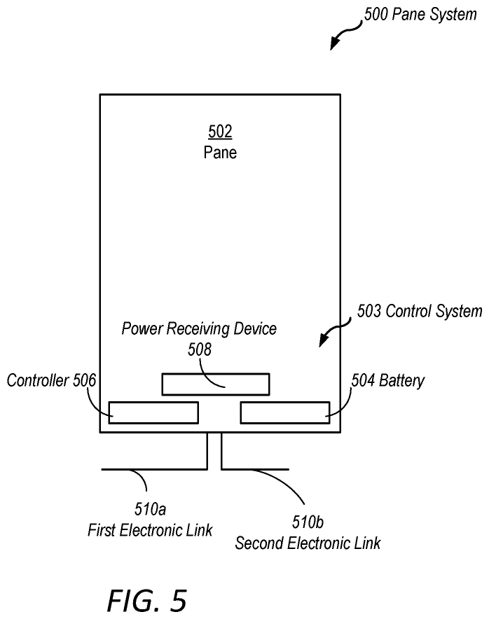

FIG. 5 illustrates an example of a pane system 500 according to some aspects. In some aspects, the pane system 500 may include one or more same or similar features as the panes described in the wired system 100 illustrated in FIG. 1, the panes described in the wired system 200 illustrated in FIG. 2, the panes described in the wireless system 300 illustrated in FIG. 3, and/or the panes described in the system 400 illustrated in FIG. 4. In some aspects, one or more features of the pane system 500 described herein may be included in the wired system 100 illustrated in FIG. 1, the wired system 200 illustrated in FIG. 2, the wireless system 300 illustrated in FIG. 3, and/or the system 400 illustrated in FIG. 4.

The pane system 500 may include a control system 503 integrated into the pane 502 (e.g., glazing). The pane 502 may be the same as or at least similar to one or more of the IGUs 104a, 104b, and 110 illustrated in FIG. 1, one or more of the IGUs 204a, 204b, 204c, and 204d illustrated in FIG. 2, one or more of the panes 302a, 302b, 302c, and 302d illustrated in FIG. 3, and/or one or more of the panes 402a, 402b, 402c, and 402d illustrated in FIG. 4. As shown in FIG. 5, the control system 503 integrated into the pane 502 may include a battery 504, a controller 506, a power receiving device 508, and/or at least one of a first electronic link 510a or a second electronic link 510b. The first electronic link 510a and/or the second electronic link 510b may be configured to provide electrical communication (e.g., electrical power, electronic data signals) with at least one other pane (e.g., another pane system 500, the panes described in the wired system 100 illustrated in FIG. 1, the panes described in the wired system 200 illustrated in FIG. 2, the panes described in the wireless system 300 illustrated in FIG. 3, and/or the panes described in the system 400 illustrated in FIG. 4). The first electronic link 510a and/or the second electronic link 510b may be the same as or at least similar one or more of the electronic links 406a, 406b, 406c, and 406d illustrated in FIG. 4. The battery 504 may be configured to supply electrical power to the pane 502 of the pane system 500 and at least one other pane via the first electronic link 510a and/or the second electronic link 510b. The battery 504 may be the same as or at least similar to one or more of the batteries 306a, 306b, 306c, and 306d illustrated in FIG. 3.

The controller 506 may configured to control the battery 504 to supply electrical power to at least one of the pane system 500 associated with the controller 506 or to at least one other pane electronically linked to the pane system 500. In some aspects, the controller 506 may configured to control the battery 504 to supply electrical power to at least one of the pane system 500 associated with the controller 506 or to at least one other pane electronically linked to the pane system 500 based at least on one of an opacity of the pane 502 of the pane system 500 or an opacity of the other pane. In some instances, the controller 506 may determine (e.g., using one or more light sensors) that an opacity of the pane 502 of the pane system 500 is below an opacity threshold and supply power from the battery 504 to the pane 502 of the pane system 500 to increase the opacity of the pane 502 of the pane system 500 so that the opacity is no longer below (e.g., above) the opacity threshold. Additionally, or alternatively, the controller 506 may determine (e.g., using one or more light sensors) that an opacity of another pane is below an opacity threshold and may supply power from the battery 504 to the other pane to increase the opacity of the other pane so that the opacity is no longer below the opacity threshold.

In some aspects, the pane system 500 may be electronically linked to an external power source (e.g., the power supply 310 of FIG. 3, the power supply 410 of FIG. 4). In addition to, or as an alternative to, the controller 504 controlling the battery 504 to supply electrical power to at least one of the pane system 500 or the other pane, the controller 506 may configured to control the external power source to supply electrical power to at least one of the pane system 500 associated with the controller 506 or to at least one other pane electronically linked to the pane system 500. For example, the controller 504 may be configured to control the battery 504 to supply electrical power to the other pane when controlling the external power source to supply electrical power to the pane system 500. In some aspects, the controller 506 may configured to control the external power source to supply electrical power to at least one of the pane system 500 associated with the controller 506 or to at least one other pane electronically linked to the pane system 500 based at least on one of an opacity of the pane 502 of the pane system 500 or an opacity of the other pane. In some instances, the controller 506 may supply power from the external power source to the pane 502 of the pane system 500 to maintain the opacity of the pane 502 of the pane system 500 so that the opacity does not fall below an opacity threshold. Additionally, or alternatively, the controller 506 may supply power from the external power source to the other pane to maintain the opacity of the other pane so that the opacity of the other pane does not fall below an opacity threshold. The controller 506 may be the same as or at least similar to one or more controllers 304a, 304b, 304c, and 304d illustrated in FIG. 3 and/or one or more controllers 404a, 404b, 404c, and 404d illustrated in FIG. 4. The power receiving device 508 may be the same as or at least similar to one or more power receiving devices 307a, 307b, 307c, and 307d illustrated in FIG. 3.

The integrated control system 503 may provide a unique (simple, single) design that supports a range of configurations which can serve a variety of systems including the wired system 100 illustrated in FIG. 1, the wired system 200 illustrated in FIG. 2, the wireless system 300 illustrated in FIG. 3, and/or the system 400 illustrated in FIG. 4. For example, pane systems 500 may be daisy-chained together and/or with one or more other panes via a framing system within integrated wiring and/or using the configuration shown in FIG. 4 (e.g., for a retrofit application). Controllers 506 of a first set of one or more pane systems 500 may be configured to distribute power from their respective batteries 504 (and/or an external power source) through at least one of the first electronic link 510a or the second electronic link 510b to one or more other panes when, for example, power receiving devices of the one or more other panes are unable to receive power. For example, when power receiving devices of the one or more other panes include one or more solar panels and shading prevents the one or more solar panels of each of the one or more other panes from receiving solar power, batteries 504 from the first set of one or more pane systems 500 may share power amongst the first set of one or more pane systems 500 and/or the one or more other panes to supply a voltage across the other panes to control an opacity of the one or more other panes.

In some aspects, the controller 506 of the pane system 500 may be configured to control a power supply from the battery 504 and/or from an external power source to facilitate fast-switching of the pane 502 and/or another pane. For example, fast-switching may utilize more power for a short duration of time to quickly change an opacity of a pane. The controller 506 of the pane system 500 may control the battery 504 to provide peak power to the pane 502 to facilitate fast-switching for a duration of time and supply average overall power using the external power supply. After the pane changes opacity by fast-switching, the controller 506 can control the external power supply to provide an average overall power to the pane while improving efficiency and reducing wire gauge and a size of the external power supply.

As described further herein, one or more components of the control system 503 (e.g., the battery 504 and/or the controller 505) may be stored in a compartment of the pane system 500 (e.g., a compartment embedded in the pane 502). The compartment may be located adjacent an edge (e.g., a corner edge) of the pane system 500 (e.g., the pane 502). In some aspects, the compartment may include an access opening configured to provide access to an interior space of the compartment where one or more components (e.g., the battery 504 and/or the controller 506) reside.

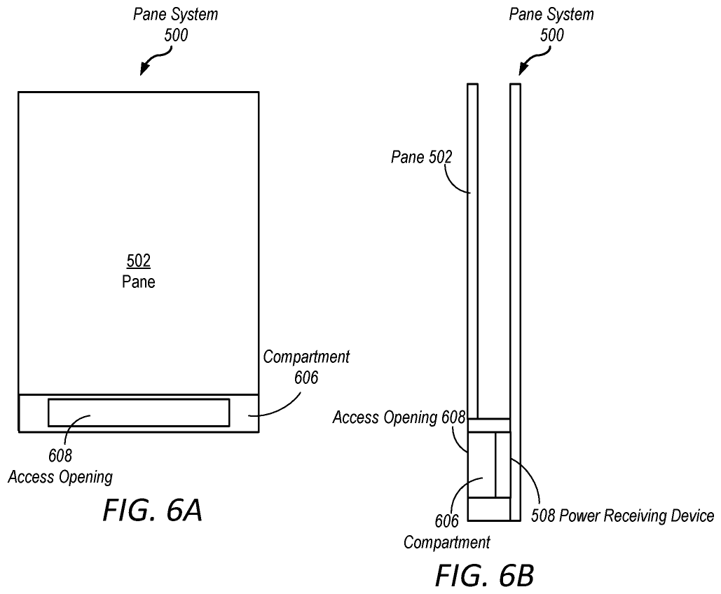

FIGS. 6A and 6B illustrate an example pane system 500 having a compartment 606 according to some aspects. FIG. 6A illustrates a front view of the example pane system 500 having the compartment 606. FIG. 6B illustrates a side view of the example pane system 500 having the compartment 606. As shown in FIGS. 6A and 6B, the pane system 500 includes a pane 502 and a compartment 606 positioned at a lower end of the pane 502. The compartment 606 is configured to retain one or more components of the control system 503 (e.g., the battery 504 and/or the controller 505). The compartment 606 may be located adjacent an edge of the pane system 500 (e.g., the pane 502) and hermetically sealed to the pane 502 with an air gap to a next pane. For example, when the pane system 500 includes a rectangular shape, the compartment 606 may be located adjacent a lower or side edge of the pane system 500 (e.g., the pane 502). In some aspects, the compartment 606 may include an access opening 608 configured to provide access to an interior space of the compartment 606 where one or more components (e.g., the battery 504 and/or the controller 506) of the control system 503 may reside. In some aspects, the compartment 606 may also include a power receiving device 508 (e.g., a photovoltaic panel or solar panel) as described herein. The compartment 606 may allow for easy access and replacement of one or more components of the control system 503 of the pane system 500 before and/or after the pane system 500 is installed in a structure. In some aspects, the entire compartment 606 including one or more components of the control system 503 may be replaced with another entire compartment 606 including one or more other components of the controller system 503. The components within the compartment 606 and/or the compartment 606 itself may be plug-and-play-ready so that when one or more components are inserted into the compartment 606 and/or when the compartment 606 itself is installed with the pane system 500 mounted in a system (e.g., the system 100, 200, 300, and/or 400) for controlling one or more panes, the one or more components are ready to operate in accordance with their respective functions.

When the compartment 606 includes the access opening 608, one or more individual components of the control system 503 residing in the compartment 606 may be removed and/or replaced without removing and/or replacing one or more other components of the control system 503 and/or without removing and/or replacing the entire compartment 606. In some aspects, the compartment 606 may be configured to engage with a magnetic pole or a drone to add, remove, and/or replace components of the control system 503 residing within the compartment 606. In some aspects, the pane 502 may be shortened to provide space for the compartment 606. For example, the pane 502 including an electrochromic layer of the pane 502 may be shortened to provide space for the compartment 606.

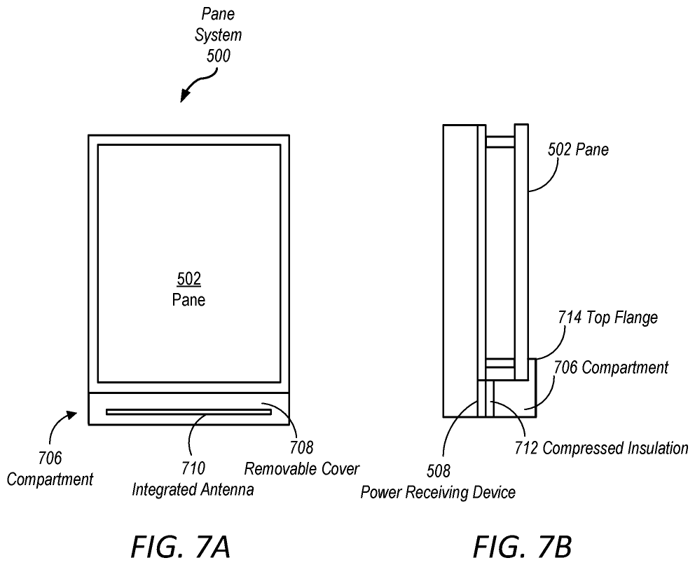

FIGS. 7A and 7B illustrate an example pane system 500 having a compartment 706 according to some aspects. FIG. 7A illustrates a front view of the example pane system 500 having the compartment 706. FIG. 7B illustrates a side view of the example pane system 500 having the compartment 706. As shown in FIGS. 7A and 7B, the pane system 500 includes a pane 502 and a compartment 706 positioned at a lower end of the pane 502. The compartment 706 may include one or more same or similar features as the compartment 606 illustrated in FIGS. 6A and 6B. In addition, the compartment 706 may include removable cover 708 and an integrated antenna 710 that is integrated into the removable cover 708. It should be understood that while FIG. 7A points a bar on the removeable cover 708 to show the integrated antenna 710, the integrated antenna 710 may be integrated within the removeable cover 708 and may not be visible from an exterior vantage point of the removeable cover 708. The compartment 706 may also include the power receiving device 508, a compressible insulation 712 separating the power receiving device 508 from an interior space of the compartment 508, and top flange 714.

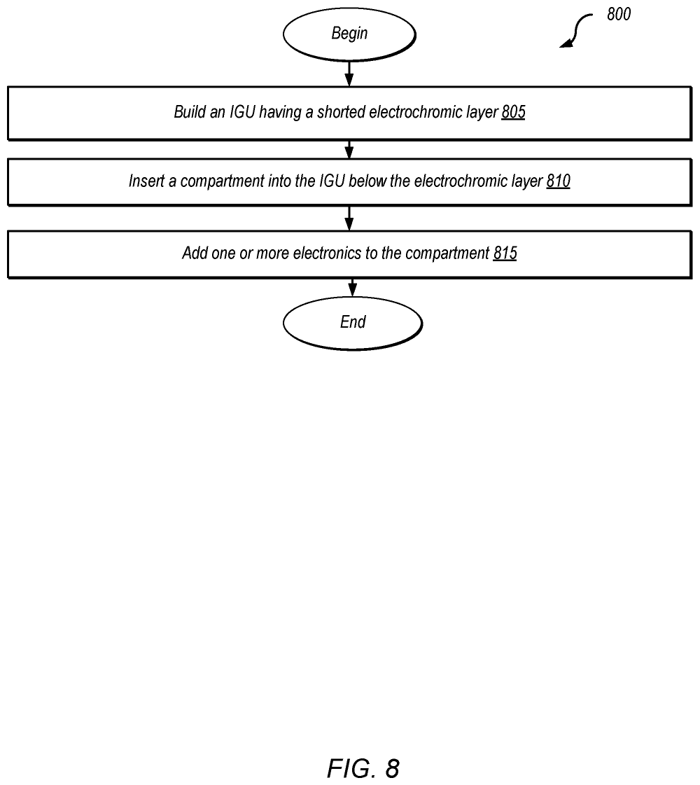

FIG. 8 illustrates an example method 800 of manufacturing a pane system 500 including a compartment 606 according to some aspects. At 805, a pane 502 (e.g., an IGU) may be built having a shortened height forming a space in the pane 502. At 810, a compartment 606 may be inserted into the space in the pane 502 formed by the shortened height. The compartment 606 may be configured to retain one or more components of a control system (e.g., the control system 503 including the battery 504 and/or the controller 505). The compartment 606 may be located adjacent an edge of the pane system 500 (e.g., the pane 502) and hermetically sealed to the pane 502 with an air gap to a next pane. For example, when the pane system 500 includes a rectangular shape, the compartment 606 may be located adjacent a lower or side edge of the pane system 500 (e.g., the pane 502). In some aspects, the compartment 606 may include an access opening 608 configured to provide access to an interior space of the compartment 606 where one or more components (e.g., the battery 504 and/or the controller 506) of the control system 503 may be inserted for use. In some aspects, the compartment 606 may also include a power receiving device 508 (e.g., a photovoltaic panel or solar panel) as described herein. The compartment 606, via the access opening 608, may allow for easy access and replacement of one or more components of the control system 503 of the pane system 500 before and/or after the pane system 500 is installed in a structure. In some aspects, the entire compartment 606 including one or more components of the control system 503 may be replaced with another entire compartment 606 including one or more other components of the controller system 503. The components within the compartment 606 and/or the compartment 606 itself may be plug-and-play-ready so that when one or more components are inserted into the compartment 606 and/or when the compartment 606 itself is installed with the pane system 500 mounted in a system (e.g., the system 100, 200, 300, and/or 400) for controlling one or more panes, the one or more components are ready to operate in accordance with their respective functions. At 815, one or more components (e.g., a battery 504, a controller 506, a power receiving device 508) of the control system 503 may be placed in an interior space of the compartment 606.

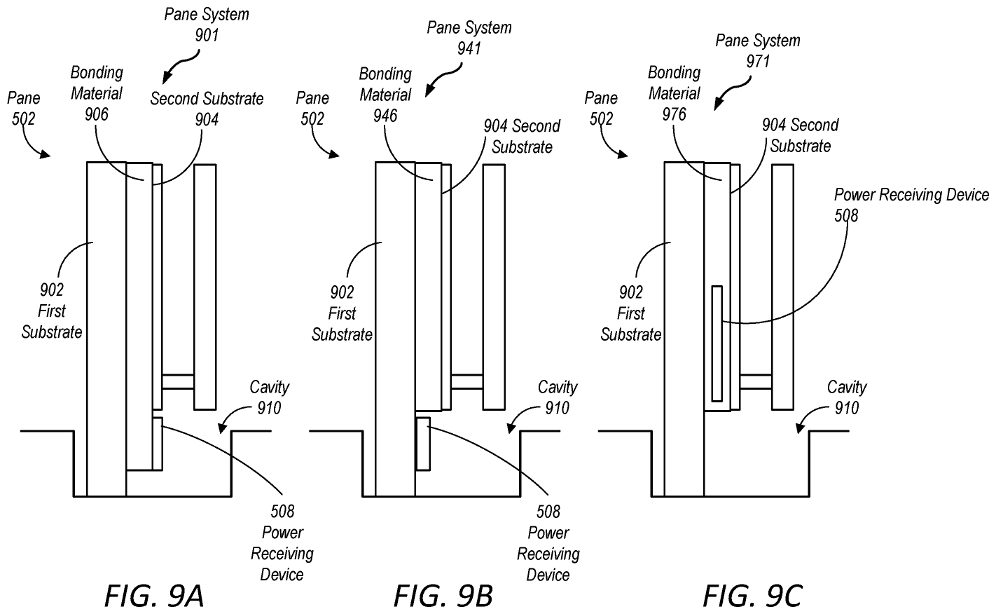

FIGS. 9A, 9B, and 9C illustrate example pane systems 901, 941, and 971, respectively, each including a power receiving device 508 according to some aspects. The pane systems 901, 941, and 971 may be the same as or at least similar to the pane system 500 illustrated in FIGS. 5, 6A, 6B, 7A, and 7B. As described herein, the power receiving device 508 may be configured to receive power wirelessly for controlling an opacity of a pane of a pane system. As shown in FIG. 9A, the pane system 901 may include a first substrate 902 (e.g., a transparent substrate, a transparent conductive layer, a pane of glass) coupled to a second substrate 904 (e.g., a transparent substrate, a transparent conductive layer, a pane of glass). The first substrate 902 may be coupled or bonded to the second substrate 904 via a bonding material 906 (e.g., an adhesive). The first substrate 902 and the bonding material 906 may extend further in a downward direction compared to the second substrate 904 such that the first substrate 902 and the bonding material 906 exposed to the ambient environment together with the second substrate 904 form a cavity 910. The power receiving device 508 may be securely fixed to the pane system 901. For example, the power receiving device 508 may be coupled or bonded to the pane 502 of the pane system 901 via the bonding material 906 adjacent the first substrate 902 and below the second substrate 904 in at least a portion of the cavity 910. When the power receiving device 508 includes a solar panel, the power receiving device 508 may be positioned at the bottom of the pane system 901 to avoid excessive shadowing on the pane 502. In some aspects, the compartment 606 may be constructed within the cavity 910 and formed around the power receiving device 508.

As shown in FIG. 9B, the pane system 941 may include the first substrate 902 coupled to the second layer 904. The first substrate 902 may be coupled or bonded to the second substrate 904 via a bonding material 946 (e.g., an adhesive). The first substrate 902 may extend further in a downward direction compared to the bonding material 946 and the second layer 904 thereby forming a cavity 910 below the bonding material 946 and the second substrate 904 adjacent the first substrate 902. The power receiving device 508 may be positioned with the pane system 901 directly against the first substrate 902 and below the second substrate 904 in at least a portion of the cavity 910. When the power receiving device 508 includes a solar panel, the power receiving device 508 may be positioned at the bottom of the pane system 941 to avoid excessive shadowing on the pane 502. In some aspects, the compartment 606 may be constructed within the cavity 910 and formed around the power receiving device 508.

As shown in FIG. 9C, the pane system 971 may include the first substrate 902 coupled to the second substrate 904. The first substrate 902 may be coupled or bonded to the second substrate 904 via a bonding material 976 (e.g., an adhesive). The first substrate 902 may extend further in a downward direction compared to the bonding material 976 and the second substrate 904 thereby forming a cavity 910 below the bonding material 976 and the second substrate 904 adjacent the first substrate 902. The power receiving device 508 may be positioned with the pane system 901 and within the bonding material 976 between the first substrate 902 and the second substrate 904, but not within the cavity 910. In some aspects, the compartment 606 may be constructed within the cavity 910. Because the power receiving device 508 is not positioned with the cavity 910, more space may be available with an interior space formed by the compartment 606.

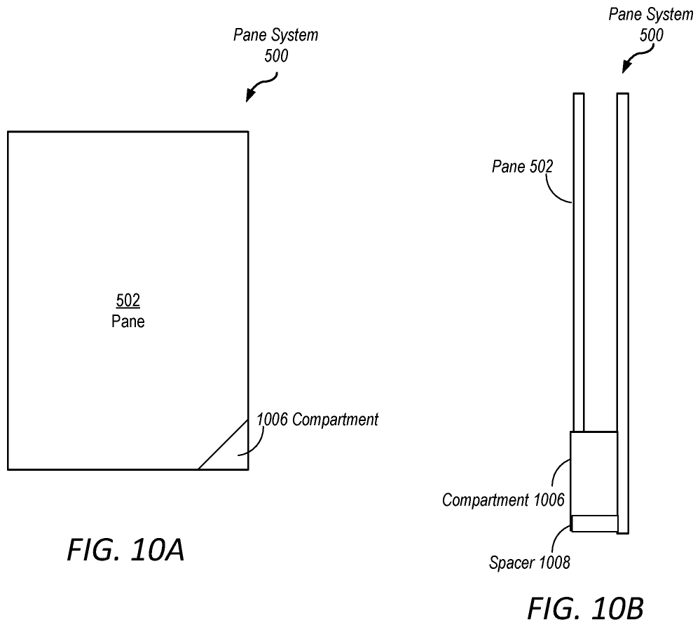

FIGS. 10A and 10B illustrate the example pane system 500 having a compartment 1006 according to some aspects. FIG. 10A illustrates a front view of the example pane system 500 having the compartment 1006. FIG. 10B illustrates a side view of the example pane system 500 having the compartment 1006. As shown in FIGS. 10A and 10B, the pane system 500 includes a pane 502 and a compartment 1006 positioned at a lower end of the pane 502. The compartment 1006 is configured to retain one or more components of the control system 503 (e.g., the battery 504 and/or the controller 505). When the pane system 500 includes a rectangular shape, the compartment 1006 may be located adjacent a corner (e.g., a lower corner, an upper corner) of the pane system 500 (e.g., the pane 502). In some aspects, the pane system 500 may include a spacer 1008 (e.g., an IGU spacer) positioned below the compartment 1006 to provide spacing between panes. In some aspects, the compartment 1006 may include an access opening configured to provide access to an interior space of the compartment 1006 where one or more components (e.g., the battery 504 and/or the controller 506) of the control system 503 may reside. The compartment 1006 may allow for easy access and replacement of one or more components of the control system 503 of the pane system 500 before and/or after the pane system 500 is installed in a structure. In some aspects, the entire compartment 1006 including one or more components of the control system 503 may be replaced with another entire compartment 1006 including one or more other components of the controller system 503. The components within the compartment 1006 and/or the compartment 1006 itself may be plug-and-play-ready so that when one or more components are inserted into the compartment 1006 and/or when the compartment 1006 itself is installed with the pane system 500 mounted in a system (e.g., the system 100, 200, 300, and/or 400) for controlling one or more panes, the one or more components are ready to operate in accordance with their respective functions. When the compartment 1006 includes the access opening, one or more individual components of the control system 503 residing in the compartment 1006 may be removed and/or replaced without removing and/or replacing one or more other components of the control system 503 and/or without removing and/or replacing the entire compartment 1006. In some aspects, the compartment 1006 may be configured to engage with a magnetic pole or a drone to add, remove, and/or replace components of the control system 503 residing within the compartment 1006.

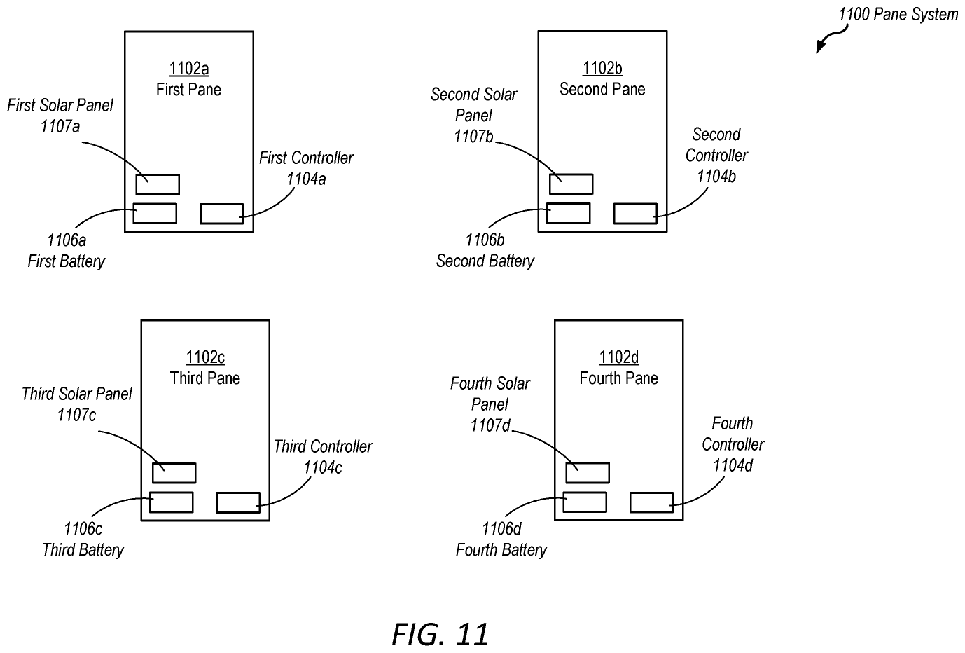

FIG. 11 illustrates an example pane system 1100 utilizing solar power according to some aspects. In some aspects, the panes of the pane system 1100 may include one or more same or similar features as the panes described in the wired system 100 illustrated in FIG. 1, the panes described in the wired system 200 illustrated in FIG. 2, the panes described in the wireless system 300 illustrated in FIG. 3, the panes described in the system 400 illustrated in FIG. 4, the panes of pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, and/or the pane(s) of pane system 971 illustrated in FIG. 9C. In some aspects, one or more features of the pane system 1100 described herein may be included in the wired system 100 illustrated in FIG. 1, the wired system 200 illustrated in FIG. 2, the wireless system 300 illustrated in FIG. 3, the system 400 illustrated in FIG. 4, the pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, 9C, and/or the pane(s) of pane system 971 illustrated in FIG. 9C.

As shown in FIG. 11, the pane system 1100 may include a plurality of panes including a first pane 1102a, a second pane 1102b, a third pane 1102c, and a fourth pane 1102d. Each of the panes may include one or more of a controller (e.g., one or more processors), a battery, or a solar panel. For example, the first pane 1102a may include a first controller 1104a, a first battery 1106a, and/or a first solar panel 1107a. The second pane 1102b may include a second controller 1104b, a second battery 1106b, and/or a second solar panel 1107b. The third pane 1102c may include a third controller 1104c, a third battery 1106c, and/or a third solar panel 1107c. The fourth pane 1102d may include a fourth controller 1104d, a fourth battery 1106d, and/or a fourth solar panel 1107d. In some aspects, the pane system 1100 may be a purely solar powered pane system and/or each pane of the pane system 1100 may operate independently of the other panes such that each of the solar panels may power the respective panes to change and/or maintain a tint of the respective panes. For example, the first solar panel 1107a may supply power to the first pane 1102a, the second solar panel 1107b may supply power to the second pane 1102b, the third solar panel 1107c may supply power to the third pane 1102c, and/or the fourth solar panel 1107d may supply power to the fourth pane 1102d.

Additionally, or alternatively, each of the solar panels may charge the respective batteries and the batteries may supply power to the respective panes to change and/or maintain a tint of the respective panes. For example, the first solar panel 1107a may supply power to the first battery 1106a for power storage. Subsequently, the first battery 1106a may supply power to the first pane 1102a to change and/or maintain a tint of the first pane 1102a. As another example, the second solar panel 1107b may supply power to the second battery 1106b for power storage. Subsequently, the second battery 1106b may supply power to the second pane 1102b to change and/or maintain a tint of the second pane 1102b. As yet another example, the third solar panel 1107c may supply power to the third battery 1106c for power storage. Subsequently, the third battery 1106c may supply power to the third pane 1102c to change and/or maintain a tint of the third pane 1102c. As another example, the fourth solar panel 1107d may supply power to the fourth battery 1106d for power storage. Subsequently, the fourth battery 1106d may supply power to the fourth pane 1102d to change and/or maintain a tint of the fourth pane 1102d.

In some cases, the controllers may control whether power is sent from the respective solar panels directly to the respective panes, whether power is sent from the respective solar panels to the respective batteries for subsequent transmission to the respective panes, and/or whether power is sent from the batteries to the respective panes. For example, the first controller 1104a may determine that the first battery 1106a is fully charged and that current amount of sun light received by the first solar panel 1107a is sufficient to change and/or maintain a tint of the first pane 1102a at a specified rate and/or a specified level of tinting (e.g., an amount of tinting). As such, the first controller 1104a may direct power from the first solar panel 1107a to the first pane 1102a to change and/or maintain a tint of the first pane 1102a while preventing power from communicating from the first solar panel 1107a to the first battery 1106a. As another example, the second controller 1104b may determine that a second battery 1106b is only partially charged and that tinting is not currently needed for the second pane 1102b. As such, the second controller 1106b may direct power from the second solar panel 1107b to the second battery 1106b for power storage and/or may prevent power from being supplied directly from the second solar panel 1107b to the second pane 1102b. As yet another example, the third controller 1104c may determine that the third battery 1106c is at least partially charged, that sun light is temporarily obstructed from reaching the third solar panel 1107c, and that power is needed to maintain and/or change a tinting of the third pane 1102c. As such, the third controller 1104c may direct power from the third battery 1106c to the third pane. In some aspects, the third controller 1104c may also direct power from the third solar panel 1107c to the third pane 1102c and/or to the third battery 1106c to use and/or store at least some electrical power from the third solar panel 1107c. As yet another example, the fourth controller 1104d may determine that the fourth pane requires an amount of power to achieve a specified rate of tint change and/or maintain a specified amount of tinting for the fourth pane 1102d that may require both power stored in the fourth battery 1106d and power provided by the fourth solar panel 1107d. As such, the fourth controller 1104d may controller the fourth solar panel 1107d to provide power directly to the fourth pane 1102d and may controller the fourth battery 1106d to provide power directly to the further pane 1102d.

In some cases, the controllers may control an amount of power sent from the solar panels to at least one of the respective panes or the respective batteries. For example, the first controller 1104a may direct a transmission of a first amount of power from the first solar panel 1107a to the first pane 1102a and a second amount of power (e.g., a remaining amount of power) from the first solar panel 1107a to the first battery 1106a for subsequent use by the first pane 1102a. Additionally, or alternatively, the first controller 1104a may direct a transmission of a first amount of power from the solar panel 1107a to the first pane 1102a and a second amount of power (e.g., a supplemental amount of power) from the first battery 1106a to the first pane 1102a.

In some aspects, a controller of a respective pane may control the amount of electrical power supplied from the solar panel to the pane based on at least one of an amount of light received by the solar panel or an amount of electrical power stored in the battery. For example, the first controller 1104a may determine that the first battery 1106a is at least partially charged and that the first solar panel 1107a is receiving an amount of light below a threshold for enabling the first solar panel 1107a to independently supply enough electrical power to the first pane 1102a. As such, the first controller 1104a may control the first solar panel 1107a to supply as much electrical energy as possible to the first pane 1102a and control the first battery 1106a to supply a remainder amount of electrical power to meet the demands of the first pane 1102a.

In some aspects, a controller of a respective pane may control an amount of electrical power supplied from a respective solar panel to a respective battery based on at least one of an amount of light received by the solar panel and an amount of electrical power stored in the battery. For example, the first controller 1104a may determine that the first battery 1106a is not fully charged and that the first solar panel 1107a is receiving more than sufficient amount of light for enabling the first solar panel 1107a to independently supply enough electrical power to the first pane 1102a. As such, the first controller 1104a may control the first solar panel 1107a to supply a sufficient amount of electrical energy to maintain or change an opacity of the first pane 1102a and supply a remainder amount of electrical power to charge the first battery 1106a.

In some aspects, a controller of a respective pane may control an amount of electrical power supplied from the battery to the pane. For example, the first controller 1104a may determine that the first battery 1106a is not fully charged and that the first pane 1102a does not require tinting and thus does not require electrical power to maintain or change a tint of the first pane 1102a. Further, the first controller 1104a may determine that the first solar panel 1107a is receiving at least some light (e.g., sun light) to produce electrical power. As such, the first controller 1104a may control the first solar panel 1107a to supply electrical power from the first solar panel 1107a to the first battery 1106a to charge the first battery 1106a.

In some aspects, a controller of a respective pane may control the amount of electrical power supplied from the battery to the pane based on at least one of an amount of light received by the solar panel and an amount of electrical power stored in the battery. For example, the first controller 1104a may determine that the first battery 1106a is at least partially charged and that the first solar panel 1107a is not able to generate electrical power to the first pane 1102a. As such, the first controller 1104a may control the first battery 1106a to supply electrical power to meet the demands (or at least attempt to meet the demands) of the first pane 1102a.

In some cases, a controller of a respective pane may control the amount of electrical power sourced from at least one of the solar panel or the battery based on at least one of an amount of light received by the pane, an amount of opacity specified for the pane, a rate of change of an amount of opacity specified for the pane. For example, the first controller 1104a may determine current power sourcing capabilities of the first battery 1106a and/or the first solar panel 1107a and control the amount of power sourced to the first pane 1102a based on the current power sourcing capabilities of the first battery 1106a, the current power sourcing capabilities of the first solar panel 1107a, an amount of opacity specified for the first pane 1102a at a particular time (or duration of time), and/or a rate of change of an amount of opacity specified for the first pane 1102a at a particular time (or a duration of time). In some cases, a controller of a respective pane may control at least one of solar panel or the battery to source electrical power to the pane based on at least one of a power demand of the pane, an available amount of power to be sourced from the battery, or an available amount of power to be sourced from the solar panel. In some aspects, in addition to or as an alternative to a solar panel, a respective pane may include a transceiver for transmitting and receiving electrical power wirelessly with at least one other EC device. As such a controller may additionally, or alternatively, control the amount of electrical power sourced to at least one of a respective battery or a respective pane based on an amount of power stored in a battery associated with another pane, an amount of power generated at a solar panel associated with the other pane, and/or electrical power needs of the other pane. In some aspects, a controller of a respective pane may control a controller of another respective pane to receive power wirelessly through the transceiver.

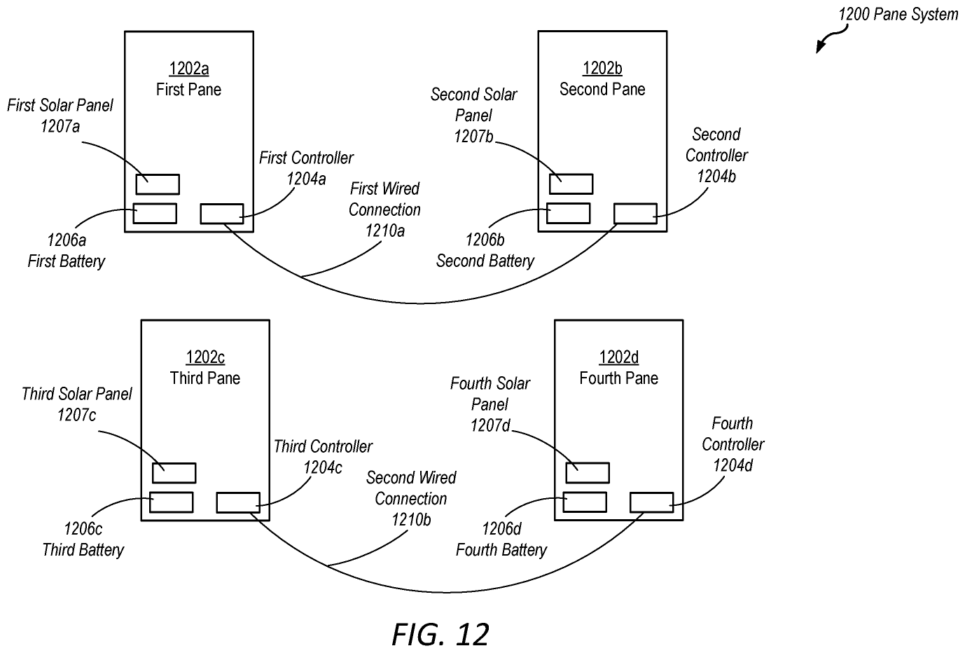

FIG. 12 illustrates an example pane system 1200 utilizing a paired solar power configuration according to some aspects. In some aspects, the panes of the pane system 1200 may include one or more same or similar features as the panes described in the wired system 100 illustrated in FIG. 1, the panes described in the wired system 200 illustrated in FIG. 2, the panes described in the wireless system 300 illustrated in FIG. 3, the panes described in the system 400 illustrated in FIG. 4, the panes of pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, the pane(s) of pane system 971 illustrated in FIG. 9C, and/or the pane(s) of the pane system 1100 illustrated in FIG. 11. In some aspects, one or more features of the pane system 1200 described herein may be included in the wired system 100 illustrated in FIG. 1, the wired system 200 illustrated in FIG. 2, the wireless system 300 illustrated in FIG. 3, the system 400 illustrated in FIG. 4, the pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, 9C, the pane(s) of pane system 971 illustrated in FIG. 9C, and/or the pane(s) of the pane system 1100 illustrated in FIG. 11.

As shown in FIG. 12, the pane system 1200 may include a plurality of panes including a first pane 1202a, a second pane 1202b, a third pane 1202c, and a fourth pane 1202d. Each of the panes may include one or more of a controller (e.g., one or more processors), a battery, or a solar panel. For example, the first pane 1202a may include a first controller 1204a, a first battery 1206a, and/or a first solar panel 1207a. The second pane 1202b may include a second controller 1204b, a second battery 1206b, and/or a second solar panel 1207b. The third pane 1202c may include a third controller 1204c, a third battery 1206c, and/or a third solar panel 1207c. The fourth pane 1202d may include a fourth controller 1204d, a fourth battery 1206d, and/or a fourth solar panel 1207d. In some aspects, the pane system 1200 may be a purely solar powered pane system and/or each pane of the pane system 1200 may operate independently of the other panes such that each of the solar panels may power the respective panes to change and/or maintain a tint of the respective panes. For example, the first solar panel 1207a may supply power to the first pane 1202a, the second solar panel 1207b may supply power to the second pane 1202b, the third solar panel 1207c may supply power to the third pane 1202c, and/or the fourth solar panel 1207d may supply power to the fourth pane 1202d.

Additionally, or alternatively, each of the solar panels may charge the respective batteries and the batteries may supply power to the respective panes to change and/or maintain a tint of the respective panes. For example, the first solar panel 1207a may supply power to the first battery 1206a for power storage. Subsequently, the first battery 1206a may supply power to the first pane 1202a to change and/or maintain a tint of the first pane 1202a. As another example, the second solar panel 1207b may supply power to the second battery 1206b for power storage. Subsequently, the second battery 1206b may supply power to the second pane 1202b to change and/or maintain a tint of the second pane 1202b. As yet another example, the third solar panel 1207c may supply power to the third battery 1206c for power storage. Subsequently, the third battery 1206c may supply power to the third pane 1202c to change and/or maintain a tint of the third pane 1202c. As another example, the fourth solar panel 1207d may supply power to the fourth battery 1206d for power storage. Subsequently, the fourth battery 1206d may supply power to the fourth pane 1202d to change and/or maintain a tint of the fourth pane 1202d.

In some cases, the controllers may control whether power is sent from the respective solar panels directly to the respective panes, whether power is sent from the respective solar panels to the respective batteries for subsequent transmission to the respective panes, and/or whether power is sent from the batteries to the respective panes. For example, the first controller 1204a may determine that the first battery 1206a is fully charged and that current amount of sun light received by the first solar panel 1207a is sufficient to change and/or maintain a tint of the first pane 1202a at a specified rate and/or a specified level of tinting (e.g., an amount of tinting). As such, the first controller 1204a may direct power from the first solar panel 1207a to the first pane 1202a to change and/or maintain a tint of the first pane 1202a while preventing power from communicating from the first solar panel 1207a to the first battery 1206a. As another example, the second controller 1204b may determine that a second battery 1206b is only partially charged and that tinting is not currently needed for the second pane 1202b. As such, the second controller 1206b may direct power from the second solar panel 1207b to the second battery 1206b for power storage and/or may prevent power from being supplied directly from the second solar panel 1207b to the second pane 1202b. As yet another example, the third controller 1204c may determine that the third battery 1206c is at least partially charged, that sun light is temporarily obstructed from reaching the third solar panel 1207c, and that power is needed to maintain and/or change a tinting of the third pane 1202c. As such, the third controller 1204c may direct power from the third battery 1206c to the third pane. In some aspects, the third controller 1204c may also direct power from the third solar panel 1207c to the third pane 1202c and/or to the third battery 1206c to use and/or store at least some electrical power from the third solar panel 1207c. As yet another example, the fourth controller 1204d may determine that the fourth pane requires an amount of power to achieve a specified rate of tint change and/or maintain a specified amount of tinting for the fourth pane 1202d that may require both power stored in the fourth battery 1206d and power provided by the fourth solar panel 1207d. As such, the fourth controller 1204d may controller the fourth solar panel 1207d to provide power directly to the fourth pane 1202d and may controller the fourth battery 1206d to provide power directly to the further pane 1202d.

In some cases, the controllers may control an amount of power sent from the solar panels to at least one of the respective panes or the respective batteries. For example, the first controller 1204a may direct a transmission of a first amount of power from the first solar panel 1207a to the first pane 1202a and a second amount of power (e.g., a remaining amount of power) from the first solar panel 1207a to the first battery 1206a for subsequent use by the first pane 1202a. Additionally, or alternatively, the first controller 1204a may direct a transmission of a first amount of power from the solar panel 1207a to the first pane 1202a and a second amount of power (e.g., a supplemental amount of power) from the first battery 1206a to the first pane 1202a.

In some aspects, a controller of a respective pane may control the amount of electrical power supplied from the solar panel to the pane based on at least one of an amount of light received by the solar panel or an amount of electrical power stored in the battery. For example, the first controller 1204a may determine that the first battery 1206a is at least partially charged and that the first solar panel 1207a is receiving an amount of light below a threshold for enabling the first solar panel 1207a to independently supply enough electrical power to the first pane 1202a. As such, the first controller 1204a may control the first solar panel 1207a to supply as much electrical energy as possible to the first pane 1202a and control the first battery 1206a to supply a remainder amount of electrical power to meet the demands of the first pane 1202a.

In some aspects, a controller of a respective pane may control an amount of electrical power supplied from a respective solar panel to a respective battery based on at least one of an amount of light received by the solar panel and an amount of electrical power stored in the battery. For example, the first controller 1204a may determine that the first battery 1206a is not fully charged and that the first solar panel 1207a is receiving more than sufficient amount of light for enabling the first solar panel 1207a to independently supply enough electrical power to the first pane 1202a. As such, the first controller 1204a may control the first solar panel 1207a to supply a sufficient amount of electrical energy to maintain or change an opacity of the first pane 1202a and supply a remainder amount of electrical power to charge the first battery 1206a.

In some aspects, a controller of a respective pane may control an amount of electrical power supplied from the battery to the pane. For example, the first controller 1204a may determine that the first battery 1206a is not fully charged and that the first pane 1202a does not require tinting and thus does not require electrical power to maintain or change a tint of the first pane 1202a. Further, the first controller 1204a may determine that the first solar panel 1207a is receiving at least some light (e.g., sun light) to produce electrical power. As such, the first controller 1204a may control the first solar panel 1207a to supply electrical power from the first solar panel 1207a to the first battery 1206a to charge the first battery 1206a.

In some aspects, a controller of a respective pane may control the amount of electrical power supplied from the battery to the pane based on at least one of an amount of light received by the solar panel and an amount of electrical power stored in the battery. For example, the first controller 1204a may determine that the first battery 1206a is at least partially charged and that the first solar panel 1207a is not able to generate electrical power to the first pane 1202a. As such, the first controller 1204a may control the first battery 1206a to supply electrical power to meet the demands (or at least attempt to meet the demands) of the first pane 1202a.

In some cases, a controller of a respective pane may control the amount of electrical power sourced from at least one of the solar panel or the battery based on at least one of an amount of light received by the pane, an amount of opacity specified for the pane, a rate of change of an amount of opacity specified for the pane. For example, the first controller 1204a may determine current power sourcing capabilities of the first battery 1206a and/or the first solar panel 1207a and control the amount of power sourced to the first pane 1202a based on the current power sourcing capabilities of the first battery 1206, the current power sourcing capabilities of the first solar panel 1207a, an amount of opacity specified for the first pane 1202a at a particular time (or duration of time), and/or a rate of change of an amount of opacity specified for the first pane 1202a at a particular time (or a duration of time). In some cases, a controller of a respective pane may control at least one of solar panel or the battery to source electrical power to the pane based on at least one of a power demand of the pane, an available amount of power sourced from the battery, or an available amount of power sourced from the solar panel. In some aspects, in addition to or as an alternative to a solar panel, a respective pane may include a transceiver for transmitting and receiving electrical power wirelessly with at least one other EC device. As such a controller may additionally, or alternatively, control the amount of electrical power sourced to at least one of a respective battery or a respective pane based on an amount of power stored in a battery associated with another pane, an amount of power generated at a solar panel associated with the other pane, and/or electrical power needs of the other pane. In some aspects, a controller of a respective pane may control a controller of another respective pane to receive power wirelessly through the transceiver.

In some aspect, a pane may be electronically paired with at least one other pane. As shown in FIG. 12, the first controller 1204a of the first pane 1202a may electronically connected via a first wired connection 1210a with the second controller 1204b of the second pane 1202b. Similarly, the third controller 1204c of the third pane 1202c may electronically connected via a second wired connection 1210b with the fourth controller 1204d of the fourth pane 1202d. As such respective controllers may communicate with paired controllers for bi-directional power sharing to receive, supply, and store power as well as provide power to respective panes as described herein.

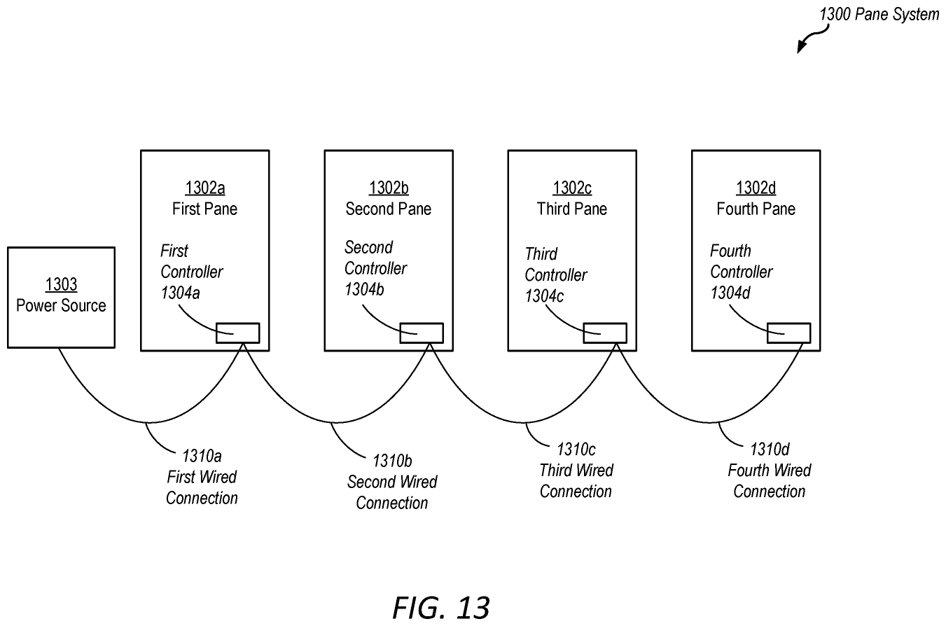

FIG. 13 illustrates an example pane system 1300 utilizing a shared power source according to some aspects. In some aspects, the panes of the pane system 1300 may include one or more same or similar features as the panes described in the wired system 100 illustrated in FIG. 1, the panes described in the wired system 200 illustrated in FIG. 2, the panes described in the wireless system 300 illustrated in FIG. 3, the panes described in the system 400 illustrated in FIG. 4, the panes of pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, the pane(s) of pane system 971 illustrated in FIG. 9C, the pane(s) of the pane system 1100 illustrated in FIG. 11, and/or the pane(s) of the pane system 1200 illustrated in FIG. 12. In some aspects, one or more features of the pane system 1300 described herein may be included in the wired system 100 illustrated in FIG. 1, the wired system 200 illustrated in FIG. 2, the wireless system 300 illustrated in FIG. 3, the system 400 illustrated in FIG. 4, the pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, 9C, the pane(s) of pane system 971 illustrated in FIG. 9C, the pane(s) of the pane system 1100 illustrated in FIG. 11, and/or the pane(s) of the pane system 1200 illustrated in FIG. 12.

As shown in FIG. 13, the pane system 1300 may include a plurality of panes including a first pane 1302a, a second pane 1302b, a third pane 1302c, and a fourth pane 1302d. Each of the panes may include one or more of a controller (e.g., one or more processors), a battery, or a solar panel. For example, the first pane 1302a may include a first controller 1304a, the second pane 1302b may include a second controller 1304b, the third pane 1302c may include a third controller 1304c, and the fourth pane 1302d may include a fourth controller 1304d. In some aspects, each of the panes may be electronically connected to together by one or more wires. For example, each of the panes may be electronically connected to each other and a power source 1303 by a daisy chain configuration of wires. As shown in FIG. 13, the first controller 1304a of the first pane 1302a may be connected to the power source 1303 via the first wired connection 1310a. The first controller 1304a of the first pane 1302a may also be connected to the second controller 1304b of the second pane 1302b via the second wired connection 1310b. Similarly, the second controller 1304b of the second pane 1302b may connected to the third controller 1304c of the third pane 1302c via the third wired connection 1310c. In addition, the third controller 1304c of the third pane 1302c may connected to the fourth controller 1304d of the fourth pane 1302d via the further wired connection 1310d. Each of the controllers of the respective panes along the daisy chain of wires may be configured to communicate with each other and the power source 1303 to receive power. For example, the third controller 1304c of the third pane 1302c may be configured to control the power source 1303 to supply electrical power to the third pane 1302c and control the first controller 1304a and the second controller 1304b to relay the power form the power source 1303 to the third controller 1304c. As another example, the first controller 1304a may controller power distribution from the power source 1303 to each of the controllers of the other respective panes. In some aspects, the controllers of the respective panes may be configured to receive power from the power source 1303, one or more a battery or a solar panel of the respective pane, and/or one or more of a battery or solar pane of another pane. In some aspects, power from the power source 1303 may simply be shared between each of the panes such that none of the controllers are making decisions about how much power is shared.

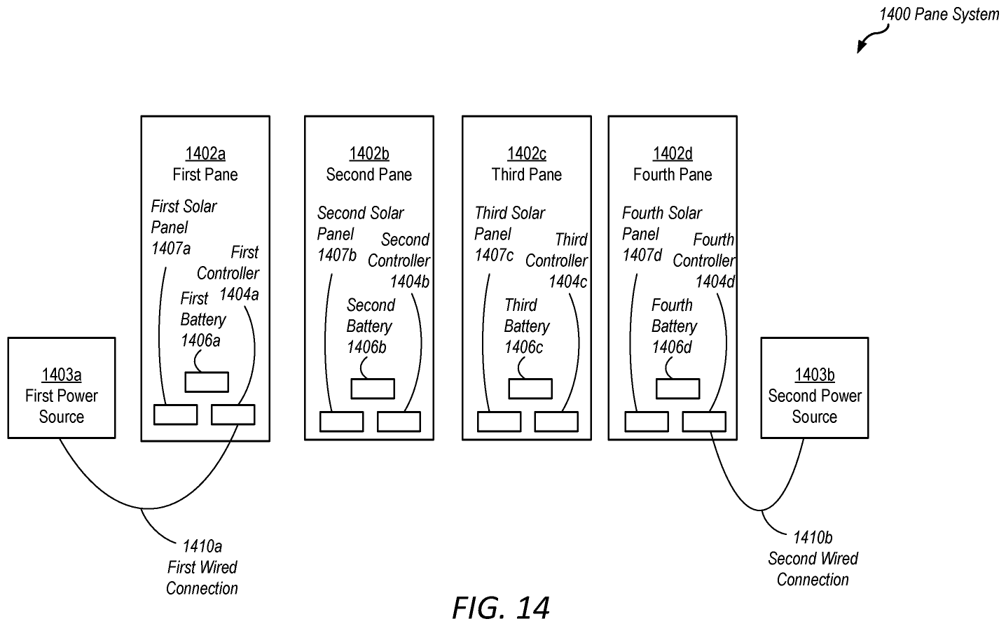

FIG. 14 illustrates an example pane system 1400 utilizing solar power and selectively utilizing an additional power source according to some aspects. In some aspects, the panes of the pane system 1400 may include one or more same or similar features as the panes described in the wired system 100 illustrated in FIG. 1, the panes described in the wired system 200 illustrated in FIG. 2, the panes described in the wireless system 300 illustrated in FIG. 3, the panes described in the system 400 illustrated in FIG. 4, the panes of pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, the pane(s) of pane system 971 illustrated in FIG. 9C, the pane(s) of the pane system 1100 illustrated in FIG. 11, the pane(s) of the pane system 1200 illustrated in FIG. 12, and/or the pane(s) of the pane system 1300 illustrated in FIG. 13. In some aspects, one or more features of the pane system 1400 described herein may be included in the wired system 100 illustrated in FIG. 1, the wired system 200 illustrated in FIG. 2, the wireless system 300 illustrated in FIG. 3, the system 400 illustrated in FIG. 4, the pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, 9C, the pane(s) of pane system 971 illustrated in FIG. 9C, the pane(s) of the pane system 1100 illustrated in FIG. 11, the pane(s) of the pane system 1200 illustrated in FIG. 12, and/or the pane(s) of the pane system 1300 illustrated in FIG. 13.

As shown in FIG. 14, the pane system 1400 may include a plurality of panes including a first pane 1402a, a second pane 1402b, a third pane 1402c, and a fourth pane 1402d. Each of the panes may include one or more of a controller (e.g., one or more processors), a battery, or a solar panel. For example, the first pane 1402a may include a first controller 1404a, a first battery 1406a, and/or a first solar panel 1407a. The second pane 1402b may include a second controller 1404b, a second battery 1406b, and/or a second solar panel 1407b. The third pane 1402c may include a third controller 1404c, a third battery 1406c, and/or a third solar panel 1407c. The fourth pane 1402d may include a fourth controller 1404d, a fourth battery 1406d, and/or a fourth solar panel 1407d. In some aspects, the pane system 1400 may be a purely solar powered pane system and/or each pane of the pane system 1400 may operate independently of the other panes such that each of the solar panels may power the respective panes to change and/or maintain a tint of the respective panes. For example, the first solar panel 1407a may supply power to the first pane 1402a, the second solar panel 1407b may supply power to the second pane 1402b, the third solar panel 1407c may supply power to the third pane 1402c, and/or the fourth solar panel 1407d may supply power to the fourth pane 1402d.

Additionally, or alternatively, each of the solar panels may charge the respective batteries and the batteries may supply power to the respective panes to change and/or maintain a tint of the respective panes. For example, the first solar panel 1407a may supply power to the first battery 1406a for power storage. Subsequently, the first battery 1406a may supply power to the first pane 1402a to change and/or maintain a tint of the first pane 1402a. As another example, the second solar panel 1407b may supply power to the second battery 1406b for power storage. Subsequently, the second battery 1406b may supply power to the second pane 1402b to change and/or maintain a tint of the second pane 1402b. As yet another example, the third solar panel 1407c may supply power to the third battery 1406c for power storage. Subsequently, the third battery 1406c may supply power to the third pane 1402c to change and/or maintain a tint of the third pane 1402c. As another example, the fourth solar panel 1407d may supply power to the fourth battery 1406d for power storage. Subsequently, the fourth battery 1406d may supply power to the fourth pane 1402d to change and/or maintain a tint of the fourth pane 1402d.

In some cases, the controllers may control whether power is sent from the respective solar panels directly to the respective panes, whether power is sent from the respective solar panels to the respective batteries for subsequent transmission to the respective panes, and/or whether power is sent from the batteries to the respective panes. In some aspects, for example, the first controller 1404a may determine that the first battery 1406a is fully charged and that current amount of sun light received by the first solar panel 1407a is sufficient to change and/or maintain a tint of the first pane 1402a at a specified rate and/or a specified level of tinting (e.g., an amount of tinting). As such, the first controller 1404a may direct power from the first solar panel 1407a to the first pane 1402a to change and/or maintain a tint of the first pane 1402a while preventing power from communicating from the first solar panel 1407a to the first battery 1406a. As another example, the second controller 1404b may determine that a second battery 1406b is only partially charged and that tinting is not currently needed for the second pane 1402b. As such, the second controller 1406b may direct power from the second solar panel 1407b to the second battery 1406b for power storage and/or may prevent power from being supplied directly from the second solar panel 1407b to the second pane 1402b. As yet another example, the third controller 1404c may determine that the third battery 1406c is at least partially charged, that sun light is temporarily obstructed from reaching the third solar panel 1407c, and that power is needed to maintain and/or change a tinting of the third pane 1402c. As such, the third controller 1404c may direct power from the third battery 1406c to the third pane. In some aspects, the third controller 1404c may also direct power from the third solar panel 1407c to the third pane 1402c and/or to the third battery 1406c to use and/or store at least some electrical power from the third solar panel 1407c. As yet another example, the fourth controller 1404d may determine that the fourth pane requires an amount of power to achieve a specified rate of tint change and/or maintain a specified amount of tinting for the fourth pane 1402d that may require both power stored in the fourth battery 1406d and power provided by the fourth solar panel 1407d. As such, the fourth controller 1404d may controller the fourth solar panel 1407d to provide power directly to the fourth pane 1402d and may controller the fourth battery 1406d to provide power directly to the further pane 1402d.

In some cases, the controllers may control an amount of power sent from the solar panels to at least one of the respective panes or the respective batteries. For example, the first controller 1404a may direct a transmission of a first amount of power from the first solar panel 1407a to the first pane 1402a and a second amount of power (e.g., a remaining amount of power) from the first solar panel 1407a to the first battery 1406a for subsequent use by the first pane 1402a. Additionally, or alternatively, the first controller 1404a may direct a transmission of a first amount of power from the solar panel 1407a to the first pane 1402a and a second amount of power (e.g., a supplemental amount of power) from the first battery 1406a to the first pane 1402a.

In some aspects, a controller of a respective pane may control the amount of electrical power supplied from the solar panel to the pane based on at least one of an amount of light received by the solar panel or an amount of electrical power stored in the battery. For example, the first controller 1404a may determine that the first battery 1406a is at least partially charged and that the first solar panel 1407a is receiving an amount of light below a threshold for enabling the first solar panel 1407a to independently supply enough electrical power to the first pane 1402a. As such, the first controller 1404a may control the first solar panel 1407a to supply as much electrical energy as possible to the first pane 1402a and control the first battery 1406a to supply a remainder amount of electrical power to meet the demands of the first pane 1402a.

In some aspects, a controller of a respective pane may control an amount of electrical power supplied from a respective solar panel to a respective battery based on at least one of an amount of light received by the solar panel and an amount of electrical power stored in the battery. For example, the first controller 1404a may determine that the first battery 1406a is not fully charged and that the first solar panel 1407a is receiving more than sufficient amount of light for enabling the first solar panel 1407a to independently supply enough electrical power to the first pane 1402a. As such, the first controller 1404a may control the first solar panel 1407a to supply a sufficient amount of electrical energy to maintain or change an opacity of the first pane 1402a and supply a remainder amount of electrical power to charge the first battery 1406a.

In some aspects, a controller of a respective pane may control an amount of electrical power supplied from the battery to the pane. For example, the first controller 1404a may determine that the first battery 1406a is not fully charged and that the first pane 1402a does not require tinting and thus does not require electrical power to maintain or change a tint of the first pane 1402a. Further, the first controller 1404a may determine that the first solar panel 1407a is receiving at least some light (e.g., sun light) to produce electrical power. As such, the first controller 1404a may control the first solar panel 1407a to supply electrical power from the first solar panel 1407a to the first battery 1406a to charge the first battery 1406a.

In some aspects, a controller of a respective pane may control the amount of electrical power supplied from the battery to the pane based on at least one of an amount of light received by the solar panel and an amount of electrical power stored in the battery. For example, the first controller 1404a may determine that the first battery 1406a is at least partially charged and that the first solar panel 1407a is not able to generate electrical power to the first pane 1402a. As such, the first controller 1404a may control the first battery 1406a to supply electrical power to meet the demands (or at least attempt to meet the demands) of the first pane 1402a.

In some cases, a controller of a respective pane may control the amount of electrical power sourced from at least one of the solar panel or the battery based on at least one of an amount of light received by the pane, an amount of opacity specified for the pane, a rate of change of an amount of opacity specified for the pane. For example, the first controller 1404a may determine current power sourcing capabilities of the first battery 1406a and/or the first solar panel 1407a and control the amount of power sourced to the first pane 1402a based on the current power sourcing capabilities of the first battery 1406, the current power sourcing capabilities of the first solar panel 1407a, an amount of opacity specified for the first pane 1402a at a particular time (or duration of time), and/or a rate of change of an amount of opacity specified for the first pane 1402a at a particular time (or a duration of time). In some cases, a controller of a respective pane may control at least one of solar panel or the battery to source electrical power to the pane based on at least one of a power demand of the pane, an available amount of power to be sourced from the battery, or an available power to be sourced from the solar panel. In some aspects, in addition to or as an alternative to a solar panel, a respective pane may include a transceiver for transmitting and receiving electrical power wirelessly with at least one other EC device. As such a controller may additionally, or alternatively, control the amount of electrical power sourced to at least one of a respective battery or a respective pane based on an amount of power stored in a battery associated with another pane, an amount of power generated at a solar panel associated with the other pane, and/or electrical power needs of the other pane. In some aspects, a controller of a respective pane may control a controller of another respective pane to receive power wirelessly through the transceiver.

In some aspect, a pane may be electronically paired with at least a power source. As shown in FIG. 14, the first controller 1404a of the first pane 1402a may electronically connected via a first wired connection 1410a with the first power source 1403a. Similarly, the fourth controller 1404d of the fourth pane 1402d may electronically connected via a second wired connection 1410b with the second power source 1403b. The first pane 1402a and the fourth pane 1402d and/or their respective solar panels 1407a and 1407d may be positioned in areas that do not receive enough sunlight (for at least some periods of time) for adequate power and may rely, via control from the respective controllers, on the first power source 1403a and the second power source 1403b, respectively, to change and/or maintain a tint of the first pane 1402a and the fourth pane 1402d. Conversely, the second pane 1402b and the third pane 1402c and their respective solar panels 1407b and 1407c may be positioned in area that do receive enough sunlight for adequate power and may not have to rely on a power source to supplement power. Thus, the first pane 1402a and the fourth pane 1402d may selectively include power sources 1403a and 1403b, respectively, for supplemental or alternative power.

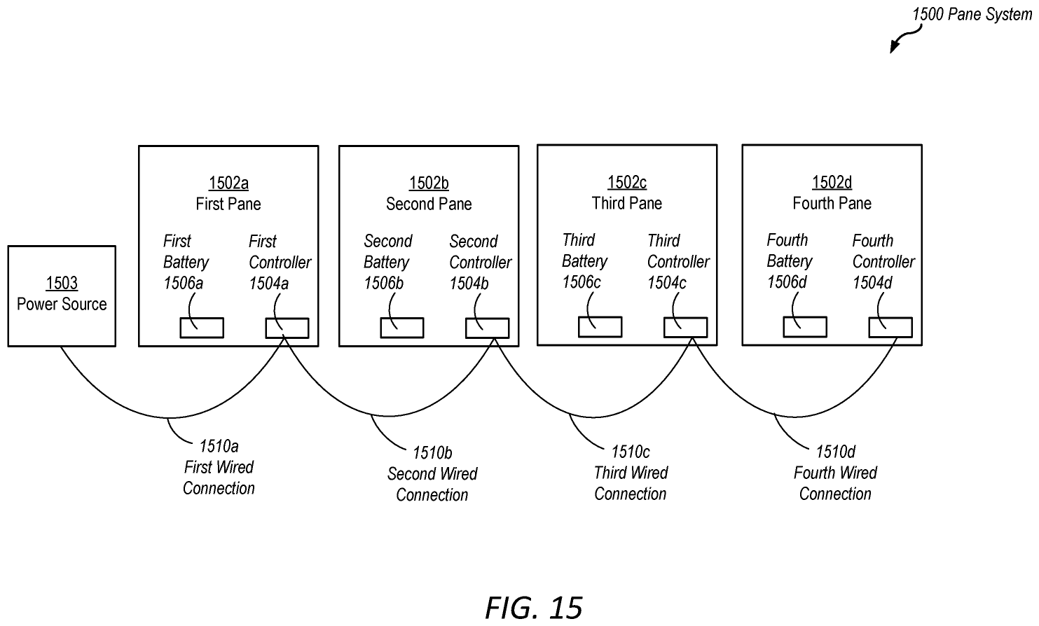

FIG. 15 illustrates an example pane system 1500 utilizing a shared power source for both power usage and power storage according to some aspects. In some aspects, the panes of the pane system 1500 may include one or more same or similar features as the panes described in the wired system 100 illustrated in FIG. 1, the panes described in the wired system 200 illustrated in FIG. 2, the panes described in the wireless system 300 illustrated in FIG. 3, the panes described in the system 400 illustrated in FIG. 4, the panes of pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, the pane(s) of pane system 971 illustrated in FIG. 9C, the pane(s) of the pane system 1100 illustrated in FIG. 11, the pane(s) of the pane system 1200 illustrated in FIG. 12, the pane(s) of the pane system 1300 illustrated in FIG. 13, and/or the pane(s) of the pane system 1400 illustrated in FIG. 14. In some aspects, one or more features of the pane system 1500 described herein may be included in the wired system 100 illustrated in FIG. 1, the wired system 200 illustrated in FIG. 2, the wireless system 300 illustrated in FIG. 3, the system 400 illustrated in FIG. 4, the pane system 500 illustrated in FIGS. 5, 6A, 6B, 7A, 7B, 10A, and 10B, the pane(s) of pane system 901 illustrated in FIG. 9A, the pane(s) of pane system 941 illustrated in FIG. 9B, 9C, the pane(s) of pane system 971 illustrated in FIG. 9C, the pane(s) of the pane system 1100 illustrated in FIG. 11, the pane(s) of the pane system 1200 illustrated in FIG. 12, the pane(s) of the pane system 1300 illustrated in FIG. 13, and/or the pane(s) of the pane system 1400 illustrated in FIG. 14.

As shown in FIG. 15, the pane system 1500 may include a plurality of panes including a first pane 1502a, a second pane 1502b, a third pane 1502c, and a fourth pane 1502d. Each of the panes may include one or more of a controller (e.g., one or more processors), a battery, or a solar panel. For example, the first pane 1502a may include a first controller 1504a and a first battery 1506a, the second pane 1502b may include a second controller 1504b and a second battery 1506b, the third pane 1502c may include a third controller 1504c and a third battery 1506c, and the fourth pane 1502d may include a fourth controller 1504d and a fourth battery 1506d. In some aspects, each of the panes may be electronically connected to together by one or more wires. For example, each of the panes may be electronically connected to each other and a power source 1503 by a daisy chain configuration of wires. As shown in FIG. 15, the first controller 1504a of the first pane 1502a may be connected to the power source 1503 via the first wired connection 1510a. The first controller 1504a of the first pane 1502a may also be connected to the second controller 1504b of the second pane 1502b via the second wired connection 1510b. Similarly, the second controller 1504b of the second pane 1502b may connected to the third controller 1504c of the third pane 1502c via the third wired connection 1510c. In addition, the third controller 1504c of the third pane 1502c may connected to the fourth controller 1504d of the fourth pane 1502d via the further wired connection 1510d. Each of the controllers of the respective panes along the daisy chain of wires may be configured to communicate with each other and the power source 1503 to receive power. For example, the third controller 1504c of the third pane 1502c may be configured to control the power source 1503 to supply electrical power to the third pane 1502c and control the first controller 1504a and the second controller 1504b to relay the power form the power source 1503 to the third controller 1504c. As another example, the first controller 1504a may controller power distribution from the power source 1503 to each of the controllers of the other respective panes. In some aspects, the controllers of the respective panes may be configured to receive power from the power source 1503, one or more a battery or a solar panel of the respective pane, and/or one or more of a battery or solar pane of another pane.

In some aspects, controllers of the respective panes may be configured to receive power from the power source 1503 and control whether to store the power from the power source in a respective battery and/or use power from the power source to change or maintain a tint of the respective pane. For example, the second controller 1504b may receive power from the power source 1503 and determine that the second pane 1502b does not require electrical power and that the second battery 1506b is not completely charged. As such, the second controller 1504b may receive power from the power source 1503 and use that power to charge the second battery 1505b. As another example, the third controller 1504c may determine that the third pane 1502c needs electrical power to change and/or maintain a tint. The third controller 1504c may also determine that the third battery 1506c is at least partially charged. As such, the third controller 1504c may control the third battery 1504c to supply at least some of the power to the third pane and may control the power source 1503 to supply another portion of the power to the third pane 1502c. Additionally, or alternatively, the third controller 1504c may request that fourth controller 1504d provide power from the fourth battery 1506d to supply another portion of power to the third pane 1504c.

In some aspects, an electrochromic (EC) device is provided. The EC device may include an electrical channel for providing electrical communication with at least one other EC device. The EC device may also include a battery configured to supply electrical power to the EC device and the at least one other EC device via the electrical channel. The EC device may further include a controller configured to control the battery to supply electrical power to at least one of the EC device or the other EC device. In some aspects, the controller is configured to control an amount of electrical power supplied from the battery to at least one of the EC device or the other EC device. In some aspects, the controller is configured to control whether electrical power is supplied from the battery to at least one of the EC device or the other EC device. In some aspects, the controller is configured to control the battery to supply electrical power to the at least one of the EC device or the other EC device based on at least one of a power demand of the EC device, a power demand of the other EC device, an available amount of power sourced from the battery of the EC device, or an available amount of power sourced from a battery of the other EC device. In some aspects, the EC device includes an external electrical channel in communication with an external power source, where the controller is configured to control the external electrical channel to supply electrical power from the external power source to at least one of the EC device or the other EC device to maintain an opacity of at least one of the EC device or the other EC. In some aspects, the external power source may include at least one of a solar power source, a wireless power source, or a wired power source. In some aspects, the EC device includes an external electrical channel in communication with an external power source, where the controller is configured to control the battery to supply electrical power to the other EC device when controlling the external electrical channel to supply electrical power from the external power source to the EC device. In some aspects, the EC device includes one or more sensors configured to detect an amount of light received by at least one of the EC device or the other EC device, where the controller is configured to control the battery to supply at least one of electrical power to the EC device or electrical power through the electrical channel for the other EC device based at least one of an opacity of the EC device or an opacity of the other EC device and based on at least one of an amount of light received, via the one or more sensors, received by at least one of the EC device or the other EC device. In some aspects, the EC device includes a compartment positioned with the EC device, where the compartment retains at least one of the battery or the controller. In some aspects, the compartment is located adjacent an edge of the EC device. In some aspects, the EC device includes a rectangular shape, and where the compartment is located adjacent a corner edge of the EC device. In some aspects, the compartment includes an access opening configured to provide access to an interior space of the compartment, where at least one of the battery or the controller resides in the interior space.

In some aspects, a system of electrochromic (EC) devices is provided. The system includes a plurality of EC devices including a first EC device and a second EC device. The first EC device includes an electrical channel for providing electrical communication with at least the second EC device of the plurality of EC devices and at least one other EC device of the plurality of EC devices in a daisy chain configuration. The first EC device also includes a battery configured to supply electrical power to the plurality of EC devices, where the battery is configured to supply electrical power to at least the second EC device of the plurality of EC devices via the electrical channel. The first EC device further includes a controller configured to control the battery to supply electrical power to the plurality of EC devices. In some aspects, the controller is configured to control the battery to supply electrical power to at least one of the EC device or the other EC device based on at least one of a power demand of the EC device, a power demand of the other EC device, an available amount of power to be sourced from the battery of the EC device, or an available amount of power to be sourced from a battery of the other EC device. In some aspects, the system includes an external electrical channel in communication with an external power source, where the controller is configured to control the external electrical channel to supply electrical power from the external power source to the plurality of EC devices to maintain an opacity of respective EC devices of the plurality of EC devices. In some aspects, the external power source includes at least one of a solar power source, a wireless power source, or a wired power source. In some aspects, the system includes an external electrical channel in communication with an external power source, where the controller is configured to control the battery to source electrical power to respective EC devices of the plurality of EC devices when controlling the external electrical channel to source electrical power from the external power source to respective EC devices of the plurality of EC devices. In some aspects, the system includes one or more sensors configured to detect an amount of light received by a respective EC device of the plurality of EC devices, where the controller is configured to control the battery to supply at least one of electrical power to the respective EC device of the plurality of EC devices or electrical power through the electrical channel for the respective EC device of the plurality of EC devices based on a respective opacity of respective EC device of the plurality of EC devices and based on an amount of light received, via the one or more sensors, received by the respective EC device of the plurality of EC devices. In some aspects, the system includes a compartment positioned within the first EC device, wherein the compartment retains at least one of the battery or the controller, and a compartment position within at least the second EC device of the plurality of EC devices, wherein the compartment retains at least one of one other battery or one other controller. In some aspects, the compartment positioned within the first EC device is located adjacent an edge of the first EC device, and the compartment positioned within the second EC device is located adjacent an edge of the second EC device. In some aspects, the first EC device includes a rectangular shape, where the compartment positioned with the first EC device is located adjacent a corner edge of the first EC device, and the second EC device includes a rectangular shape, where the compartment positioned with the second EC device is located adjacent a corner edge of the second EC device. In some aspects, the compartment positioned within the first EC device includes an access opening configured to provide access to an interior space of the compartment positioned within the first EC device, and the compartment positioned within the second EC device includes an access opening configured to provide access to an interior space of the compartment positioned within the second EC device.

In some aspects, an electrochromic (EC) device is provided. The EC device includes an electrical channel for providing electrical communication with at least one other EC device. The EC device also includes a compartment forming an interior space within the EC device. The compartment includes therein a battery configured to supply electrical power to the EC device and the at least one other EC device via the electrical channel. The compartment also includes therein a controller configured to control the battery to supply electrical power to at least one of the EC device or the other EC device. In some aspects, the controller is configured to control the battery to supply electrical power to at least one of the EC device or the other EC device based on at least one of a power demand of the EC device, a power demand of the other EC device, an available power supply of the battery of the EC device, or an available power supply of a battery of the other EC device. In some aspects, the EC device includes an external electrical channel in communication with an external power source, where the controller is configured to control the external electrical channel to supply electrical power from the external power source to at least one of the EC device or the other EC device to maintain an opacity of at least one of the EC device or the other EC. In some aspects, the external power source includes at least one of a solar power source, a wireless power source, or a wired power source. In some aspects, the EC device includes an external electrical channel in communication with an external power source, where the controller is configured to control the battery to supply electrical power to the other EC device when controlling the external electrical channel to supply electrical power from the external power source to the EC device. In some aspects, the EC device includes one or more sensors configured to detect an amount of light received by at least one of the EC device or the other EC device, where the controller is configured to control the battery to supply at least one of electrical power to the EC device or electrical power through the electrical channel for the other EC device based at least one of an opacity of the EC device or an opacity of the other EC device and based on at least one of an amount of light received, via the one or more sensors, received by at least one of the EC device or the other EC device.

In some aspects, an electrochromic (EC) device is provided. The EC device includes a pane. The EC device also includes a solar panel configured to supply electrical power to at least one of a battery or the pane. The battery is configured to store electrical power and supply electrical power to the pane. The EC device further includes a controller. The controller is configured to control the solar panel to supply electrical power to at least one of the pane or the battery, and control the battery to supply electrical power to the pane. In some aspects, the controller is configured to control an amount of electrical power supplied from the solar panel to the pane. In some aspects, the controller is configured to control the amount of electrical power supplied from the solar panel to the pane based on at least one of an amount of light received by the solar panel or an amount of electrical power stored in the battery. In some aspects, the controller is configured to control the amount of electrical power supplied from the solar panel to the pane based on at least one of an amount of light received by the solar panel or an amount of electrical power stored in the battery. In some aspects, the controller is configured to control an amount of electrical power supplied from the battery to the pane. In some aspects, the controller is configured to control the amount of electrical power supplied from the battery to the pane based on at least one of an amount of light received by the solar panel and an amount of electrical power stored in the battery. In some aspects, the controller is configured to control an amount of electrical power supplied from at least one of the solar panel or the battery based on at least one of an amount of light received by the pane, an amount of opacity specified for the pane, a rate of change of an amount of opacity specified for the pane. In some aspects, the controller is configured to control at least one of the solar panel or the battery to supply electrical power to the pane based on at least one of a power demand of the pane, an available power supply of the battery, or an available power supply of the solar panel. In some aspects, the EC further includes a transceiver configured to transmit and receive electrical power wirelessly with at least one other EC device. In some aspects, the controller is configured to control at least one of the battery or the solar panel to supply electrical power wirelessly, via the transceiver, to at least one of a pane of the other EC device or a battery of the other EC device. In some aspects, the controller is configured to communicate with a controller of the other EC device to control at least one of a battery of the other EC device or a solar panel of the other EC device to supply electrical power wirelessly, via the transceiver, to at least one of the pane or the battery. In some aspects, the controller is configured to control an amount of electrical power supplied wirelessly, via the transceiver, from at least one of a battery of the other EC device or a solar panel of the other EC device and to at least one of the pane or the battery. In some aspects, the controller is configured to control an amount of electrical power supplied wirelessly, via the transceiver, from at least one of the battery or the solar panel and to at least one of a battery of the other EC device or a pane of the other EC device.

In some aspects, an electrochromic (EC) device is provided. The EC device includes a pane. The EC device also includes a solar panel configured to supply electrical power to at least the pane. The EC further includes a wired connection providing electrical communication with at least one other EC device. The EC device includes a controller. The controller is configured to control the solar panel to supply electrical power to at least the pane, and control electrical communication of electrical power through the wired connection with the other EC device. In some aspects, the controller is configured to control the other EC device to supply electrical power, via the wired connection, from at least one of a battery of the other EC device or a solar panel of the other EC device and to at least the pane. In some aspects, the EC further includes a battery configured to store electrical power and supply electrical power to the pane and the controller is configured to control the other EC device to supply electrical power, via the wired connection, from at least one of a battery of the other EC device or a solar panel of the other EC device and to at least one of the battery or the pane. In some aspects, the controller is further configured to control the battery to supply electrical power to at least one of the pane, the battery, the battery of the other EC device via the wired connection, or a pane of the other EC device via the wired connection. In some aspects, the controller is configured to control an amount of electrical power supplied from the solar panel to the battery based on at least one of an amount of light received by the solar panel or an amount of electrical power received from the other EC device via the wired connection. In some aspects, the controller is configured to control an amount of electrical power supplied from the solar panel to the pane based on at least one of an amount of light received by the solar panel or an amount of electrical power received from the other EC device via the wired connection.

In some aspects, a system is provided. The system includes a plurality of electrochromic (EC) device, where respective EC devices of the plurality of EC device include a pane configured to change and maintain an opacity therethrough. The system also includes at least one controller physically attached to at least one EC device of the plurality of EC devices. The system further includes a wired connection daisy-chained between respective EC devices of the plurality of EC devices. The system includes at least one power source in electrical communication with respective EC devices of the plurality of EC devices via the wired connection. The at least one controller is configured to control an amount of electrical power supplied to respective EC devices of the plurality of EC devices from the power supply via the wired connection. In some aspects, the power supply includes at least one of a battery, a solar panel, or a continuous power supply source. In some aspects, the at least one controller includes a plurality of controllers each physically attached to respective EC devices of the plurality of EC device. In some aspects, the system includes a plurality of batteries, wherein respective batteries of the plurality of batteries are configured to provide electrical power to at least respective EC devices of the plurality of EC devices. In some aspects, at least one respective battery of the respective batteries is configured to provide electrical power to at least one other EC device of the plurality of EC devices.

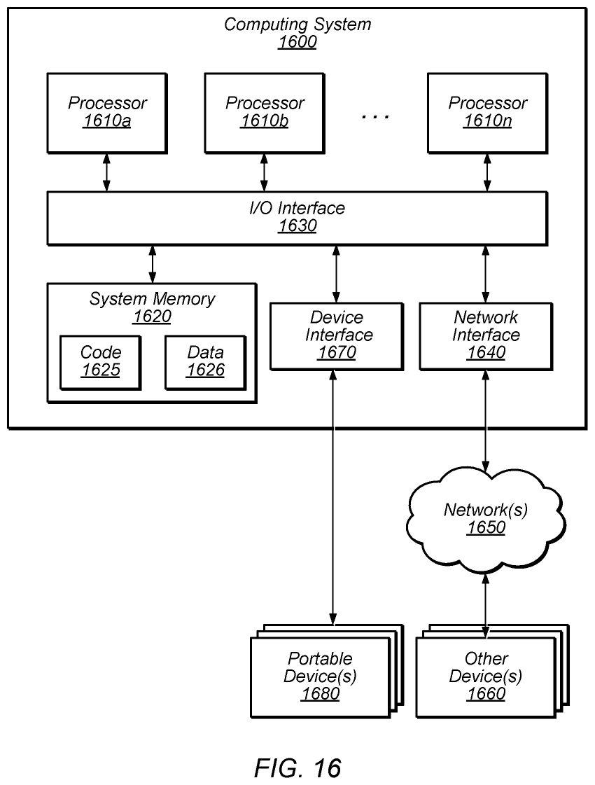

FIG. 16 illustrates an example computing system 1600 that may be used in some embodiments. The computing system 1600 may be the same as or at least similar to one or more computing systems describes in FIGS. 1-15. For example, the computing system 1600 may include the controller 506 described herein. The methods described herein may in various embodiments be implemented by any combination of hardware and software. For example, in one embodiment, the methods may be implemented by a computer system (e.g., a computer system as in FIG. 16) that includes one or more processors executing program instructions stored on a computer-readable storage medium coupled to the processors. The program instructions may implement the functionality described herein (e.g., the functionality of various computing systems, devices, or servers and other components that implement the system at the provider site and/or the customer site and the associated project databases as described herein). The various methods as illustrated in the figures and described herein represent example embodiments of methods. The order of any method may be changed, and various elements may be added, reordered, combined, omitted, modified, etc.

FIG. 16 is a block diagram illustrating a computing system according to various embodiments, as well as various other systems, components, services or devices described herein. Computing system 1600 may be any of various types of devices, including, but not limited to, a personal computer system, desktop computer, laptop or notebook computer, mainframe computer system, handheld computer, workstation, network computer, a consumer device, application server, storage device, telephone, mobile telephone, or in general any type of computing device.

Computing system 1600 includes one or more processors 1610 (any of which may include multiple cores, which may be single or multi-threaded) coupled to a system memory 1620 via an input/output (I/O) interface 1630. Computing system 1600 further includes a network interface 1640 coupled to I/O interface 1630. In various embodiments, computing system 1600 may be a uniprocessor system including one processor 1610, or a multiprocessor system including several processors 1610 (e.g., two, four, eight, or another suitable number). Processors 1610 may be any suitable processors capable of executing instructions. For example, in various embodiments, processors 1610 may be general-purpose or embedded processors implementing any of a variety of instruction set architectures (ISAs), such as the x86, PowerPC, SPARC, or MIPS ISAs, or any other suitable ISA. In multiprocessor systems, each of processors 1610 may commonly, but not necessarily, implement the same ISA. The computing system 1600 also includes one or more network communication devices (e.g., network interface 1640) for communicating with other systems and/or components over a communications network (e.g., Internet, LAN, etc.).

In the illustrated embodiment, computing system 1600 is coupled to one or more portable storage devices 1680 via device interface 1670. In various embodiments, portable storage devices 1680 may correspond to disk drives, tape drives, solid state memory, other storage devices, or any other persistent storage device. Computing system 1600 (or a distributed application or operating system operating thereon) may store instructions and/or data in portable storage devices 1680, as desired, and may retrieve the stored instruction and/or data as needed.

Computing system 1600 includes one or more system memories 1620 that can store instructions and data accessible by processor(s) 1610. In various embodiments, system memories 1620 may be implemented using any suitable memory technology, (e.g., one or more of cache, static random access memory (SRAM), DRAM, RDRAM, EDO RAM, DDR 16 RAM, synchronous dynamic RAM (SDRAM), Rambus RAM, EEPROM, non-volatile/Flash-type memory, or any other type of memory). System memory 1620 may contain program instructions 1625 that are executable by processor(s) 1610 to implement the methods and techniques described herein. In various embodiments, program instructions 1625 may be encoded in platform native binary, any interpreted language such as Java™ byte-code, or in any other language such as C/C++, Java™, etc., or in any combination thereof. For example, in the illustrated embodiment, program instructions 1625 include program instructions executable to implement the functionality of a system, local controller, project database, etc., in different embodiments. In some embodiments, program instructions 1625 may implement multiple systems, project databases, and/or other components.

In some embodiments, program instructions 1625 may include instructions executable to implement an operating system (not shown), which may be any of various operating systems, such as UNIX, LINUX, Solaris™, MacOS™, Windows™, etc. Any or all of program instructions 1625 may be provided as a computer program product, or software, which may include a non-transitory computer-readable storage medium having stored thereon instructions, which may be used to program a computer system (or other electronic devices) to perform a process according to various embodiments. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to computing system 1600 via I/O interface 1630. A non-transitory computer-readable storage medium may also include any volatile or non-volatile media such as RAM (e.g., SDRAM, DDR SDRAM, RDRAM, SRAM, etc.), ROM, etc., that may be included in some embodiments of computing system 1600 as system memory 1620 or another type of memory. In other embodiments, program instructions may be communicated using optical, acoustical or other form of propagated signal (e.g., carrier waves, infrared signals, digital signals, etc.) conveyed via a communication medium such as a network and/or a wireless link, such as may be implemented via network interface 1640.

In some embodiments, system memory 1620 may include data store 1626, which may be implemented as described herein. For example, the information described herein as being stored by the project database may be stored in data store 1626, or in another portion of system memory 1620 on one or more nodes, in other devices 1660.

In one embodiment, I/O interface 1630 may coordinate I/O traffic between processor 1610, system memory 1620 and any peripheral devices in the system, including through network interface 1640 or other peripheral interfaces, such as device interface 1670. In some embodiments, I/O interface 1630 may perform any necessary protocol, timing or other data transformations to convert data signals from one component (e.g., system memory 1620) into a format suitable for use by another component (e.g., processor 1610). In some embodiments, I/O interface 1630 may include support for devices attached through various types of peripheral buses, such as a variant of the Peripheral Component Interconnect (PCI) bus standard or the Universal Serial Bus (USB) standard, for example. In some embodiments, the function of I/O interface 1630 may be split into two or more separate components, such as a north bridge and a south bridge, for example. Also, in some embodiments, some or all of the functionality of I/O interface 1630, such as an interface to system memory 1620, may be incorporated directly into processor 1610.

Network interface 1640 may allow data to be exchanged between computing system 1600 and other devices attached to a network, such as other computer systems 1660. In addition, network interface 1640 may allow communication between computing system 1600 and various I/O devices and/or remote storage devices. Input/output devices may, in some embodiments, include one or more display terminals, keyboards, keypads, touchpads, scanning devices, voice or optical recognition devices, or any other devices suitable for entering or retrieving data by one or more computer systems 1600. Multiple input/output devices may be present in computing system 1600 or may be distributed on various nodes of a distributed system that includes computing system 1600. In some embodiments, similar input/output devices may be separate from computing system 1600 and may interact with one or more nodes of a distributed system that includes computing system 1600 through a wired or wireless connection, such as over network interface 1640. Network interface 1640 may commonly support one or more wireless networking protocols (e.g., Wi-Fi/IEEE 802.11, or another wireless networking standard). However, in various embodiments, network interface 1640 may support communication via any suitable wired or wireless general data networks, such as other types of Ethernet networks, for example. Additionally, network interface 1640 may support communication via telecommunications/telephony networks such as analog voice networks or digital fiber communications networks, via storage area networks such as Fibre Channel SANs, or via any other suitable type of network and/or protocol. In various embodiments, computing system 1600 may include more, fewer, or different components than those illustrated in FIG. 16 (e.g., displays, video cards, audio cards, peripheral devices, other network interfaces such as an ATM interface, an Ethernet interface, a Frame Relay interface, etc.).

Although the embodiments above have been described in considerable detail, numerous variations and modifications may be made as would become apparent to those skilled in the art once the above disclosure is fully appreciated. It is intended that the following claims be interpreted to embrace all such modifications and changes and, accordingly, the above description to be regarded in an illustrative rather than a restrictive sense.

What is claimed is:

1. An electrochromic (EC) device comprising:
an electrical channel for providing electrical communication with at least one other EC device;
a battery configured to supply electrical power to the EC device and the at least one other EC device via the electrical channel; and
a controller configured to control the battery to supply electrical power to at least one of the EC device or the other EC device.

2. The EC device of claim 1, wherein the controller is configured to control an amount of electrical power supplied from the battery to at least one of the EC device or the other EC device.

3. The EC device of claim 1, wherein the controller is configured to control whether electrical power is supplied from the battery to at least one of the EC device or the other EC device.

4. The EC device of claim 1, wherein the controller is configured to control the battery to supply electrical power to the at least one of the EC device or the other EC device based on at least one of a power demand of the EC device, a power demand of the other EC device, an available amount of power sourced from the battery of the EC device, or an available amount of power sourced from a battery of the other EC device.

5. The EC device of claim 1, further comprising an external electrical channel in communication with an external power source, wherein the controller is configured to control the external electrical channel to supply electrical power from the external power source to at least one of the EC device or the other EC device to maintain an opacity of at least one of the EC device or the other EC.

6. The EC device of claim 5, wherein the external power source comprises at least one of a solar power source, a wireless power source, or a wired power source.

7. The EC device of claim 1, further comprising an external electrical channel in communication with an external power source, wherein the controller is configured to control the battery to supply electrical power to the other EC device when controlling the external electrical channel to supply electrical power from the external power source to the EC device.

8. The EC device of claim 1, further comprising one or more sensors configured to detect an amount of light received by at least one of the EC device or the other EC device, wherein the controller is configured to control the battery to supply at least one of electrical power to the EC device or electrical power through the electrical channel for the other EC device based at least one of an opacity of the EC device or an opacity of the other EC device and based on at least one of an amount of light received, via the one or more sensors, received by at least one of the EC device or the other EC device.

9. A system of electrochromic (EC) devices, comprising:
a plurality of EC devices comprising a first EC device and a second EC device, the first EC device comprising:
an electrical channel for providing electrical communication with at least the second EC device of the plurality of EC devices and at least one other EC device of the plurality of EC devices in a daisy chain configuration;
a battery configured to supply electrical power to the plurality of EC devices, wherein the battery is configured to supply electrical power to at least the second EC device of the plurality of EC devices via the electrical channel; and
a controller configured to control the battery to supply electrical power to the plurality of EC devices.

10. The system of claim 9, wherein the controller is configured to control the battery to supply electrical power to at least one of the EC device or the other EC device based on at least one of a power demand of the EC device, a power demand of the other EC device, an available amount of power to be sourced from the battery of the EC device, or an available amount of power to be sourced from a battery of the other EC device.

11. The system of claim 9, further comprising an external electrical channel in communication with an external power source, wherein the controller is configured to control the external electrical channel to supply electrical power from the external power source to the plurality of EC devices to maintain an opacity of respective EC devices of the plurality of EC devices.

12. The system of claim 11, wherein the external power source comprises at least one of a solar power source, a wireless power source, or a wired power source.

13. The system of claim 9, further comprising an external electrical channel in communication with an external power source, wherein the controller is configured to control the battery to source electrical power to respective EC devices of the plurality of EC devices when controlling the external electrical channel to source electrical power from the external power source to respective EC devices of the plurality of EC devices.

14. The system of claim 9, further comprising one or more sensors configured to detect an amount of light received by a respective EC device of the plurality of EC devices, wherein the controller is configured to control the battery to supply at least one of electrical power to the respective EC device of the plurality of EC devices or electrical power through the electrical channel for the respective EC device of the plurality of EC devices based on a respective opacity of respective EC device of the plurality of EC devices and based on an amount of light received, via the one or more sensors, received by the respective EC device of the plurality of EC devices.

15. An electrochromic (EC) device comprising:
a pane;
a solar panel configured to supply electrical power to at least the pane;
a wired connection providing electrical communication with at least one other EC device; and
a controller configured to:
control the solar panel to supply electrical power to at least the pane, and
control electrical communication of electrical power through the wired connection with the other EC device.

16. The EC device of claim 15, wherein the controller is configured to control the other EC device to supply electrical power, via the wired connection, from at least one of a battery of the other EC device or a solar panel of the other EC device and to at least the pane.

17. The EC device of claim 15, wherein:
the EC further comprises a battery configured to store electrical power and supply electrical power to the pane; and
the controller is configured to control the other EC device to supply electrical power, via the wired connection, from at least one of a battery of the other EC device or a solar panel of the other EC device and to at least one of the battery or the pane.

18. The EC device of claim 17, wherein the controller is further configured to control the battery to supply electrical power to at least one of the pane, the battery, the battery of the other EC device via the wired connection, or a pane of the other EC device via the wired connection.

19. The EC device of claim 17, wherein the controller is configured to control an amount of electrical power supplied from the solar panel to the battery based on at least one of an amount of light received by the solar panel or an amount of electrical power received from the other EC device via the wired connection.

20. The EC device of claim 15, wherein the controller is configured to control an amount of electrical power supplied from the solar panel to the pane based on at least one of an amount of light received by the solar panel or an amount of electrical power received from the other EC device via the wired connection.
